(19) United States
(12) Patent Application Publication
(10) Pub. No.: US 2020/0111060 A1
(43) Pub. Date: Apr. 9, 2020

(54) TASK REMINDER METHOD AND APPARATUS, AND METHOD AND APPARATUS FOR GENERATING AND PRESENTING REMINDER MESSAGE

(71) Applicant: Alibaba Group Holding Limited, Grand Cayman (KY)

(72) Inventors: Boyu Yang, Hangzhou (CN); Ming Zhang, Hangzhou (CN); Feng BAO, Hangzhou (CN); Jiarui Shi, Hangzhou (CN)

(21) Appl. No.: 16/705,054

(22) Filed: Dec. 5, 2019

Related U.S. Application Data
(63) Continuation of application No. PCT/CN2018/088810, filed on May 29, 2018.

(30) Foreign Application Priority Data
Jun. 6, 2017 (CN) 201710417476.9

(51) Int. Cl. G06Q 10/10

(52) U.S. Cl. CPC G06Q 10/1097; G06Q 10/1095

(57) ABSTRACT

A task reminder method including: receiving, by a client terminal, a task reminder message generation instruction related to a meeting reminder message; determining, by the client terminal, a reminded object and task description information; and sending, by the client terminal, a task reminder message comprising the task description information and related to the meeting reminder message to the reminded object. By using the technical solution of the present disclosure, an association is established between a meeting reminder message and a task reminder message, so that a user quickly views related information of an associated meeting in the process of processing a task, which is conducive to improving the task processing efficiency.

### CROSS REFERENCE TO RELATED PATENT APPLICATIONS

This application claims priority to and is a continuation of PCT Patent Application No. PCT/CN2018/088810, filed on 29 May 2018 and entitled “TASK REMINDER METHOD AND APPARATUS, AND METHOD AND APPARATUS FOR GENERATING AND PRESENTING REMINDER MESSAGE,” which claims priority to Chinese Patent Application No. 201710417476.9 filed on 6 Jun. 2017 and entitled “TASK REMINDER METHOD AND APPARATUS, AND METHOD AND APPARATUS FOR GENERATING AND PRESENTING REMINDER MESSAGE,” which are incorporated herein by reference in their entirety.

### TECHNICAL FIELD

The present disclosure relates to the field of terminal technologies, and, more particularly, to task reminder methods and apparatuses, and methods and apparatuses for generating and presenting a reminder message.

### BACKGROUND

In conventional techniques, mobile enterprise office platforms are more and more widely used in office processes of enterprises, educational institutions, government agencies and other groups These platforms not only improve the communication efficiency between users and reduce communication costs, but also effectively improve the event processing efficiency and office efficiency of the users.

For example, a mobile enterprise office platform may be used to send a reminder message. The reminder message may be sent based on an instant messaging function provided by the mobile enterprise office platform or a conventional mobile communication mode such as a short message, a phone call, etc., to ensure a reminding effect.

In conventional techniques, reminder messages are independent of each other. For example, a user creates a reminder message 1 and a reminder message 2 associated with an event 1 at a moment A and a moment B respectively. Although the reminder message 1 and the reminder message 2 are both objectively associated with the event 1, when viewing the reminder message 1, the user does not retrieve the content of the reminder message 2 and has even forgotten the reminder message 2; and as a result, the user cannot process the event 1 smoothly. Moreover, in some cases, even if the user vaguely remembers the reminder message 2, the user may also fail to quickly find the reminder message 2 because of a large number of reminder messages.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Task reminder methods and apparatuses, and methods and apparatuses for generating and presenting a reminder message are provided in the present disclosure, which establish an association between a meeting reminder message and a task reminder message, so that a user may quickly view related information of an associated meeting in the process of processing a task, and are conducive to improving the task processing efficiency.

The present disclosure provides the following technical solutions.

According to a first example embodiment of the present disclosure, a task reminder method is provided, comprising:
receiving, by a client terminal, a task reminder message generation instruction related to a meeting reminder message;
determining, by the client terminal, a reminded object and task description information; and
sending, by the client terminal, a task reminder message including the task description information and related to the meeting reminder message to the reminded object.

According to a second example embodiment of the present disclosure, a task reminder method is provided, comprising:
receiving, by a client terminal, a task reminder message related to a meeting reminder message; and
presenting, by the client terminal, task description information included in the task reminder message and meeting description information in the meeting reminder message.

According to a third example embodiment of the present disclosure, a task reminder method is provided, comprising:
receiving, by a client terminal, a task reminder message generation instruction related to a meeting reminder message;
determining, by the client terminal, a reminded object and task description information; and
sending, by the client terminal, a task reminder message related to a meeting corresponding to the meeting reminder message to a reminded object that participates in the meeting and a task reminder message unrelated to the meeting to a reminded object that does not participate in the meeting, the task reminder message including the task description information.

According to a fourth example embodiment of the present disclosure, a task reminder method is provided, comprising:
receiving, by a client terminal, a task reminder message related to a meeting reminder message;
determining, by the client terminal, whether a logged-in user participates in a meeting corresponding to the meeting reminder message; and
presenting, by the client terminal, task description information included in the task reminder message and presenting meeting description information of the meeting when the logged-in user participates in the meeting; and presenting, by the client terminal, the task description information included in the task reminder message when the logged-in user does not participate in the meeting.

According to a fifth example embodiment of the present disclosure, a method for generating a reminder message is provided, comprising:
receiving, by a client terminal, a reminder message generation instruction related to a first reminder message;
determining, by the client terminal, a reminded object and reminder event description information; and
sending, by the client terminal, a second reminder message including the reminder event description information and related to the first reminder message to the reminded object.

According to a sixth example embodiment of the present disclosure, a method for generating a reminder message is provided, comprising:
generating, by a client terminal, a second reminder message related to a first reminder message according to a reminded object, reminder event description information, and the first reminder message; and
sending, by the client terminal, the second reminder message including the reminder event description information to the reminded object.

According to a seventh example embodiment of the present disclosure, a method for presenting a reminder message is provided, comprising:
receiving, by a client terminal, a second reminder message related to a first reminder message; and
presenting, by the client terminal, second reminder event description information included in the second reminder message and first reminder event description information corresponding to the first reminder message.

According to an eighth example embodiment of the present disclosure, a task reminder method is provided, comprising:
receiving, by a client terminal, a task reminder message generation instruction related to a meeting;
determining, by the client terminal, a reminded object and task description information; and
sending, by the client terminal, a task reminder message including the task description information and related to the meeting to the reminded object.

According to a ninth example embodiment of the present disclosure, a task reminder method is provided, comprising:
generating, by a client terminal, a task reminder message related to a meeting according to a reminded object, task description information, and the meeting; and
sending, by the client terminal, the task reminder message including the task description information to the reminded object.

According to a tenth example embodiment of the present disclosure, a task reminder method is provided, comprising:
receiving, by a client terminal, a task reminder message related to a meeting; and
presenting, by the client terminal, task description information included in the task reminder message and meeting description information of the meeting.

According to an eleventh example embodiment of the present disclosure, a task reminder apparatus is provided, comprising:
a first instruction receiving unit configured to cause a client terminal to receive a task reminder message generation instruction related to a meeting reminder message;
a first determination unit configured to cause the client terminal to determine a reminded object and task description information; and
a first sending unit configured to cause the client terminal to send a task reminder message including the task description information and related to the meeting reminder message to the reminded object.

According to a twelfth example embodiment of the present disclosure, a task reminder apparatus is provided, comprising:
a first message receiving unit configured to cause a client terminal to receive a task reminder message related to a meeting reminder message; and
a first presentation unit configured to cause the client terminal to present task description information included in the task reminder message and meeting description information in the meeting reminder message.

According to a thirteenth example embodiment of the present disclosure, a task reminder apparatus is provided, comprising:
a second instruction receiving unit configured to cause a client terminal to receive a task reminder message generation instruction related to a meeting reminder message;
a second determination unit configured to cause the client terminal to determine a reminded object and task description information; and
a second sending unit configured to cause the client terminal to send a task reminder message related to a meeting corresponding to the meeting reminder message to a reminded object that participates in the meeting and a task reminder message unrelated to the meeting to a reminded object that does not participate in the meeting, the task reminder message including the task description information.

According to a fourteenth example embodiment of the present disclosure, a task reminder apparatus is provided, comprising:
a second message receiving unit configured to cause a client terminal to receive a task reminder message related to a meeting reminder message;
a user type determination unit configured to cause the client terminal to determine whether a logged-in user participates in a meeting corresponding to the meeting reminder message; and
a second presentation unit configured to cause the client terminal to present task description information included in the task reminder message and present meeting description information of the meeting when the logged-in user participates in the meeting; and cause the client terminal to present the task description information included in the task reminder message when the logged-in user does not participate in the meeting.

According to a fifteenth example embodiment of the present disclosure, an apparatus for generating a reminder message is provided, comprising:
a third instruction receiving unit configured to cause a client terminal to receive a reminder message generation instruction related to a first reminder message;
a third determination unit configured to cause the client terminal to determine a reminded object and reminder event description information; and
a third sending unit configured to cause the client terminal to send a second reminder message including the reminder event description information and related to the first reminder message to the reminded object.

According to a sixteenth example embodiment of the present disclosure, an apparatus for generating a reminder message is provided, comprising:
a first generation unit configured to cause a client terminal to generate a second reminder message related to a first reminder message according to a reminded object, reminder event description information, and the first reminder message; and
a fourth sending unit configured to cause the client terminal to send the second reminder message including the reminder event description information to the reminded object.

According to a seventeenth example embodiment of the present disclosure, an apparatus for presenting a reminder message is provided, comprising:
a third message receiving unit configured to cause a client terminal to receive a second reminder message related to a first reminder message; and
a third presentation unit configured to cause the client terminal to present second reminder event description information included in the second reminder message and present first reminder event description information corresponding to the first reminder message.

According to an eighteenth example embodiment of the present disclosure, a task reminder apparatus is provided, comprising:
a fourth instruction receiving unit configured to cause a client terminal to receive a task reminder message generation instruction related to a meeting;
a fourth determination unit configured to cause the client terminal to determine a reminded object and task description information; and
a fifth sending unit configured to cause the client terminal to send a task reminder message including the task description information and related to the meeting to the reminded object.

According to a nineteenth example embodiment of the present disclosure, a task reminder apparatus is provided, comprising:
a second generation unit configured to cause a client terminal to generate a task reminder message related to a meeting according to a reminded object, task description information, and the meeting; and
a sixth sending unit configured to cause the client terminal to send the task reminder message including the task description information to the reminded object.

According to a twentieth example embodiment of the present disclosure, a task reminder apparatus is provided, comprising:
a fourth message receiving unit configured to cause a client terminal to receive a task reminder message related to a meeting; and
a fourth presentation unit configured to cause the client terminal to present task description information included in the task reminder message and present meeting description information of the meeting.

According to a twenty-first example embodiment of the present disclosure, a task reminder method is provided, comprising:
receiving a task reminder message generation instruction related to a meeting reminder message;
determining a reminded object and task description information; and
sending a task reminder message including the task description information and related to the meeting reminder message to the reminded object.

According to a twenty-second example embodiment of the present disclosure, a task reminder method is provided, comprising:
receiving a task reminder message related to a meeting reminder message; and
presenting task description information included in the task reminder message, and presenting meeting description information in the meeting reminder message.

According to a twenty-third example embodiment of the present disclosure, a task reminder method is provided, comprising:
receiving a task reminder message generation instruction related to a meeting reminder message;
determining a reminded object and task description information; and
sending a task reminder message related to a meeting corresponding to the meeting reminder message to a reminded object that participates in the meeting and a task reminder message unrelated to the meeting to a reminded object that does not participate in the meeting, the task reminder message including the task description information.

According to a twenty-fourth example embodiment of the present disclosure, a task reminder method is provided, comprising:
receiving a task reminder message related to a meeting reminder message;
determining whether a logged-in user participates in a meeting corresponding to the meeting reminder message; and
presenting task description information included in the task reminder message and presenting meeting description information of the meeting when the logged-in user participates in the meeting; and presenting, by a client terminal, the task description information included in the task reminder message when the logged-in user does not participate in the meeting.

According to a twenty-fifth example embodiment of the present disclosure, a method for generating a reminder message is provided, comprising:
receiving a reminder message generation instruction related to a first reminder message;
determining a reminded object and reminder event description information; and
sending a second reminder message including the reminder event description information and related to the first reminder message to the reminded object.

According to a twenty-sixth example embodiment of the present disclosure, a method for generating a reminder message is provided, comprising:
generating a second reminder message related to a first reminder message according to a reminded object, reminder event description information, and the first reminder message; and
sending the second reminder message including the reminder event description information to the reminded object.

According to a twenty-seventh example embodiment of the present disclosure, a method for presenting a reminder message is provided, comprising:
receiving a second reminder message related to a first reminder message; and
presenting second reminder event description information included in the second reminder message, and presenting first reminder event description information corresponding to the first reminder message.

According to a twenty-eighth example embodiment of the present disclosure, a task reminder method is provided, comprising:
receiving a task reminder message generation instruction related to a meeting;
determining a reminded object and task description information; and
sending a task reminder message including the task description information and related to the meeting to the reminded object.

According to a twenty-ninth example embodiment of the present disclosure, a task reminder method is provided, comprising:
generating a task reminder message related to a meeting according to a reminded object, task description information, and the meeting; and
sending the task reminder message including the task description information to the reminded object.

According to a thirtieth example embodiment of the present disclosure, a task reminder method is provided, comprising:
receiving a task reminder message related to a meeting; and
presenting task description information included in the task reminder message, and presenting meeting description information of the meeting.

As shown from the above technical solutions, in the present disclosure, a task reminder message and a meeting reminder message are associated, so that a user quickly views related information of an associated meeting during processing of a task, which are conducive to improving the task processing efficiency. Moreover, an association is established between any type of reminder messages, so that when viewing any of the reminder messages, the user quickly view other associated reminder messages without manually searching for them, which is conducive to improving the efficiency of the user in acquiring related information and processing related events.

### BRIEF DESCRIPTION OF THE DRAWINGS

In order to illustrate the technical solutions in the example embodiments of the present disclosure more clearly, the following briefly describes the accompanying drawings which aid in describing the example embodiments. Apparently, the accompanying drawings in the following description merely show some of the example embodiments of the present disclosure, and persons of ordinary skill in the art may derive other drawings from these accompanying drawings without creative efforts.

FIG. 1 is a schematic architectural diagram of a task reminder system according to an exemplary embodiment of the present disclosure.

FIG. 2 is a flowchart of a sender-based task reminder method according to an exemplary embodiment of the present disclosure.

FIG. 3 is a flowchart of a recipient-based task reminder method according to an exemplary embodiment of the present disclosure.

FIG. 4 is a flowchart of another sender-based task reminder method according to an exemplary embodiment of the present disclosure.

FIG. 5 is a flowchart of another recipient-based task reminder method according to an exemplary embodiment of the present disclosure.

FIG. 6 is a schematic diagram of a meeting detail interface according to an exemplary embodiment of the present disclosure.

FIG. 7 is a schematic diagram of a meeting task creation interface according to an exemplary embodiment of the present disclosure.

FIG. 8 is a schematic diagram of another meeting detail interface according to an exemplary embodiment of the present disclosure.

FIG. 9 is a schematic diagram of a leader selection interface according to an exemplary embodiment of the present disclosure.

FIG. 10 is a schematic diagram of a reminder message management interface according to an exemplary embodiment of the present disclosure.

FIG. 11 is a schematic diagram of a task details interface according to an exemplary embodiment of the present disclosure.

FIG. 12 is a schematic diagram of another reminder message management interface according to an exemplary embodiment of the present disclosure.

FIG. 13 is a schematic diagram of still another reminder message management interface according to an exemplary embodiment of the present disclosure.

FIG. 14 is a schematic diagram of still another reminder message management interface according to an exemplary embodiment of the present disclosure.

FIG. 15 is a schematic diagram of another task details interface according to an exemplary embodiment of the present disclosure.

FIG. 16 is a schematic diagram of still another task details interface according to an exemplary embodiment of the present disclosure.

FIG. 17 is a schematic diagram of still another reminder message management interface according to an exemplary embodiment of the present disclosure.

FIG. 18 is a schematic diagram of still another reminder message management interface according to an exemplary embodiment of the present disclosure.

FIG. 19 is a schematic diagram of still another reminder message management interface according to an exemplary embodiment of the present disclosure.

FIG. 20 is a flowchart of still another sender-based task reminder method according to an exemplary embodiment of the present disclosure.

FIG. 21 is a schematic diagram of a management calendar interface according to an exemplary embodiment of the present disclosure.

FIG. 22 is a flowchart of still another sender-based task reminder method according to an exemplary embodiment of the present disclosure.

FIG. 23 is a flowchart of still another recipient-based task reminder method according to an exemplary embodiment of the present disclosure.

FIG. 24 is a flowchart of a method for generating a reminder message according to an exemplary embodiment of the present disclosure.

FIG. 25 is a flowchart of another method for generating a reminder message according to an exemplary embodiment of the present disclosure.

FIG. 26 is a flowchart of a method for presenting a reminder message according to an exemplary embodiment of the present disclosure.

FIG. 27 is a schematic structural diagram of an electronic device according to an exemplary embodiment of the present disclosure.

FIG. 28 is a block diagram of a sender-based task reminder apparatus according to an exemplary embodiment of the present disclosure.

FIG. 29 is a block diagram of a recipient-based task reminder apparatus according to an exemplary embodiment of the present disclosure.

FIG. 30 is a block diagram of another sender-based task reminder apparatus according to an exemplary embodiment of the present disclosure.

FIG. 31 is a block diagram of another recipient-based task reminder apparatus according to an exemplary embodiment of the present disclosure.

FIG. 32 is a block diagram of still another sender-based task reminder apparatus according to an exemplary embodiment of the present disclosure.

FIG. 33 is a block diagram of still another sender-based task reminder apparatus according to an exemplary embodiment of the present disclosure.

FIG. 34 is a block diagram of still another recipient-based task reminder apparatus according to an exemplary embodiment of the present disclosure.

FIG. 35 is a schematic structural diagram of another electronic device according to an exemplary embodiment of the present disclosure.

FIG. 36 is a block diagram of an apparatus for generating a reminder message according to an exemplary embodiment of the present disclosure.

FIG. 37 is a block diagram of another apparatus for generating a reminder message according to an exemplary embodiment of the present disclosure.

FIG. 38 is a schematic structural diagram of still another electronic device according to an exemplary embodiment of the present disclosure.

FIG. 39 is a block diagram of an apparatus for presenting a reminder message according to an exemplary embodiment of the present disclosure.

### DETAILED DESCRIPTION

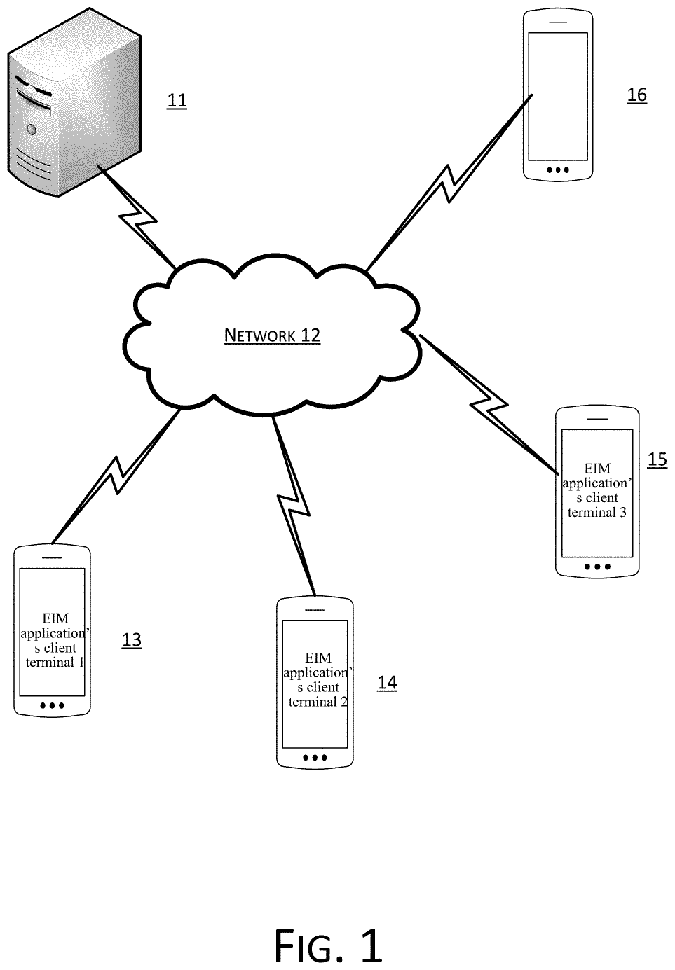

FIG. 1 is a schematic architectural diagram of a task reminder system according to an exemplary embodiment of the present disclosure. As shown in FIG. 1, the system may include a server 11, a network 12, and several electronic devices, such as a mobile phone 13, a mobile phone 14, a mobile phone 15, and a mobile phone 16.

The server 11 may be a physical server including a separate host, or the server 11 may be a virtual server hosted by a host cluster, or the server 11 may be a cloud server. In the running process, the server 11 may run a program at a server side of a certain application to implement related service functions of the application. For example, when the server 11 runs a program of a mobile group office platform, it may be implemented as a server terminal of the mobile group office platform. In the technical solution of the present disclosure, the server 11 may cooperate with client terminals running on the mobile phone 13-16 to implement functions of sending and receiving task reminder messages.

The mobile group office platform not only may implement a communication function, but also may serve as an integrated function platform of many other functions, for example, group internal events such as processing on examination and approval events (such as leave, office supplies application, finance and other examination and approval events), attendance events, task events, and log events, as well as group external events such as processing on meal ordering and purchasing, which is not limited in the present disclosure. More specifically, the mobile group office platform may be hosted in an instant messaging application in conventional techniques, for example, in an Enterprise Instant Messaging (EIM) application such as Skype For Business®, Microsoft Teams®, Yammer®, Workplace®, Slack®, Enterprise WeChat®, fxiaoke®, Enterprise Fetion®, and Enterprise Easychat®. Certainly, the instant messaging function is only one of the communication functions supported by the mobile group office platform. The group office platform may also implement more other functions like the above, as well as an activity reminding function to be implemented in the present disclosure, which will not be described in detail here.

The mobile phones 13-16 are only one type of electronic devices available for the user. In fact, the user obviously may also use the following types of electronic devices: tablet devices, notebook computers, Personal Digital Assistants (PDAs), wearable devices (such as smart glasses and smart watches), and so on, which is not limited in the present disclosure. In the running process, the electronic device may run a program at a client terminal side of a certain application to implement related service functions of the application. For example, when the electronic device runs a program of a mobile group office platform, the electronic device may be implemented as a client terminal of the mobile group office platform, for implementing functions such as generating, sending, receiving, and presenting a task reminder message in the present disclosure. An application of a client terminal of the mobile enterprise office platform may be installed in an electronic device in advance, so that the client terminal may be started up and run on the electronic device. Certainly, when an online “client terminal” such as an HTML5 technology is adopted, the client terminal may be obtained and run without the need of installing the corresponding application on the electronic device.

The network 12 over which the mobile phones 13-16 and the server 11 interact with each other may include various types of wired or wireless networks. In an embodiment, the network 12 may include a Public Switched Telephone Network (PSTN) and the Internet. At the same time, communication interaction between the mobile phones 13-16 and other electronic devices may also be conducted over the network 12. For example, a single chat communication session is established between any two electronic devices; alternatively, several electronic devices may participate in the same group chat communication session so that any user may send a communication message to all other users in the group chat communication session through his/her own electronic device. For example, when the group chat communication session is an inter-group communication session among a plurality of groups, group members in the groups may conduct group chat communication through the inter-group communication session. For another example, each electronic device may send a task-type reminder message to one or more other electronic devices over the network 12 to implement the task reminder function of the present disclosure.

A long connection may be established between the server 11 and the mobile phone 13-16 over the network 12, so that the server 11 may send a push message or the like to the mobile phone 13-16 by the long connection, and the mobile phone 13-16 may also send a message or the like to the server 11 based on the long connection. Alternatively, a communication process based on the network 12 may also be implemented between the server 11 and the mobile phone 13-16 by other methods, which will not be described one by one here.

Based on the task reminder system as shown in FIG. 1, electronic devices such as the mobile phones 13-16 may be used by a sender and a recipient, so that the electronic device used by the sender may run a sender client terminal of the task reminder message and the electronic device used by the recipient may run a recipient client terminal of the task reminder message. The sender client terminal may generate a task reminder message related to one or more meeting reminder messages, and send the task reminder message to the recipient client terminal. For example, the sender client terminal may send the task reminder message to the recipient client terminal through the server terminal run by the server 11, and the recipient client terminal may present the received task reminder message to the recipient, so that the recipient may understand corresponding task description information through the task reminder message, and may also understand meeting description information of an associated meeting reminder message through the task reminder message. The technical solution of the present disclosure is described below in combination with processing logic of the sender client terminal and the recipient client terminal.

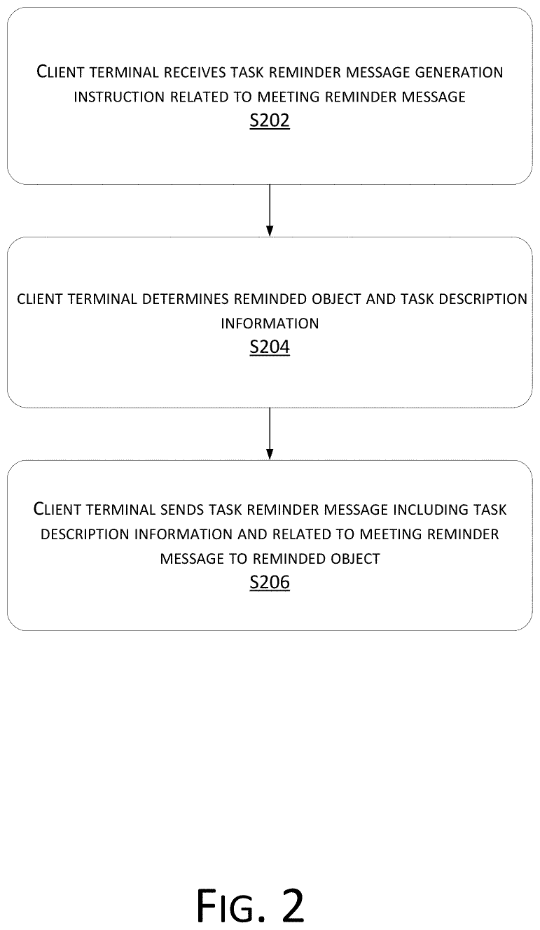

FIG. 2 is a flowchart of a sender-based task reminder method according to an exemplary embodiment of the present disclosure. As shown in FIG. 2, the method is applied to an electronic device of a sender, and may include the following steps.

In step 202, a client terminal receives a task reminder message generation instruction related to a meeting reminder message.

In this embodiment, the client terminal may provide many types of reminder messages. For example, a meeting reminder message is used for implementing a reminding function for a meeting event, and a task reminder message is used for implementing a reminding function for a task event. By setting corresponding types of the reminder messages, it is convenient for a user to classify different reminder messages for display and management, which is conducive to improving the reminding effect of the reminder messages and improving the event processing efficiency of the user.

In this embodiment, the client terminal may provide multiple ways of generating a task reminder message, so there are multiple ways of acquiring the above task reminder message generation instruction related to the meeting reminder message, which is not limited in the present disclosure. For example,

In an implementation mode, the client terminal may display a task creation option in a presentation interface of the meeting reminder message; and then the client terminal may determine that the task reminder message generation instruction is received when receiving a trigger operation for the task creation option. The presentation interface of the meeting reminder message includes any interface in which the meeting reminder message may be displayed, for example, a detail presentation interface specific to the meeting reminder message, or a reminder message management page for centralized display of the meeting reminder message and other reminder messages, and so on. Certainly, in addition to displaying a task creation option and performing a trigger operation on the task creation option by the user, the client terminal may also provide other triggering forms for the meeting reminder message, for example, draw a preset touch gesture on the above presentation interface, send a control voice, and so on, which is not limited in the present disclosure. In addition, the “task creation option” is only an available option form, and another task-related function option may also be applied here to replace the “task creation option.” For example, the function option may be a “task editing option” or “task modification option.” When the “task editing option” or “task modification option” is triggered, a task reminder message template related to the meeting reminder message may be displayed to enable the sender to edit or modify the template to obtain a task reminder message related to the meeting reminder message.

In another implementation mode, the client terminal may receive a user creation operation for the task reminder message and a meeting binding operation for the task reminder message; and then the client terminal may determine that the task reminder message generation instruction related to the meeting reminder message is received when the meeting reminder message is selected by the meeting binding operation. For example, the client terminal may provide the user with a user creation operation for the task reminder message, and when the user triggers the creation option through the user creation operation, the client terminal may further provide the user with an alternative meeting reminder message (such as meeting reminder messages that have been received and sent by the client terminal) to allow the user to select, through a user selection operation, a meeting reminder message that the user wants to bind to the task reminder message.

In step 204, the client terminal determines a reminded object and task description information.

In this embodiment, the reminded object may include at least one of the following: a participant of a meeting corresponding to the meeting reminder message, and an object that is selected by an object selection operation received by the client terminal. In an implementation mode, the client terminal may present the participant of the meeting and an associated user of the sender as alternative users to allow the sender to select a sender-wanted user to serve as the reminded object. In another implementation mode, the client terminal may take the participant of the meeting as the reminded object by default and present the associated user of the sender as an alternative user for presentation to allow the sender to further add the sender-wanted user to serve as the reminded object. In one case, the participant of the meeting may be set to be required as the reminded object, and in the other case, although the participant of the meeting is added as the reminded object by default, the sender may make adjustment according to an actual situation.

In step 206, the client terminal sends a task reminder message including the task description information and related to the meeting reminder message to the reminded object.

In an embodiment, the task reminder message may further include meeting description information in the meeting reminder message. That is, the client terminal may add at least one piece of meeting description information in the meeting reminder message to the task reminder message to display it to a recipient.

In another embodiment, the task reminder message may not include the meeting description information. For example, in one case, the task reminder message may include identification information of the meeting reminder message, so that after receiving the task reminder message, the recipient client terminal may acquire at least one piece of corresponding meeting description information from the server terminal based on the identification information, or search for the corresponding meeting reminder message and meeting description information thereof in historical reminder messages of the recipient client terminal based on the identification information. In another case, the client terminal may inform the server terminal of association information between the task reminder message and the meeting reminder message, and the task reminder message may include a meeting association ID. The meeting association ID may indicate to the recipient client terminal that the task reminder message has an associated meeting reminder message, and the recipient client terminal may initiate an inquiry to the server terminal, so that the server terminal returns at least one piece of meeting description information of the corresponding meeting reminder message to the recipient client terminal based on the above association information.

In this embodiment, when the reminded object does not participate in a meeting corresponding to the meeting reminder message, the reminded object is equivalent to being independent of the participants of the meeting, so the reminded object may have a task management permission for the task reminder message to determine the task processing status of the reminded object.

In this embodiment, when the reminded object participates in the meeting and is configured as a task leader, the reminded object may have a task management permission for the task reminder message. When the reminded object participates in the meeting and is configured as a task participant, the reminded object may not have a task management permission for the task reminder message. In this case, the task leader and the task participant are equivalent to a whole, and the task leader implements a unified task management operation on behalf of the whole.

It should be noted that in addition to being applicable to a client terminal run on an electronic device of a sender such as a mobile phone or a PC so that the client terminal implements functions such as generating and sending a task reminder message, in some cases, the embodiment shown in FIG. 2 is also applicable to a server terminal so that the server terminal implements the functions such as generating and sending a task reminder message by running the steps included in the embodiment. Even in some cases, the embodiment shown in FIG. 2 may be further applied to other possible execution bodies, and the execution bodies implement the functions such as generating and sending a task reminder message by running the steps included in the embodiment, which is not limited in the present disclosure.

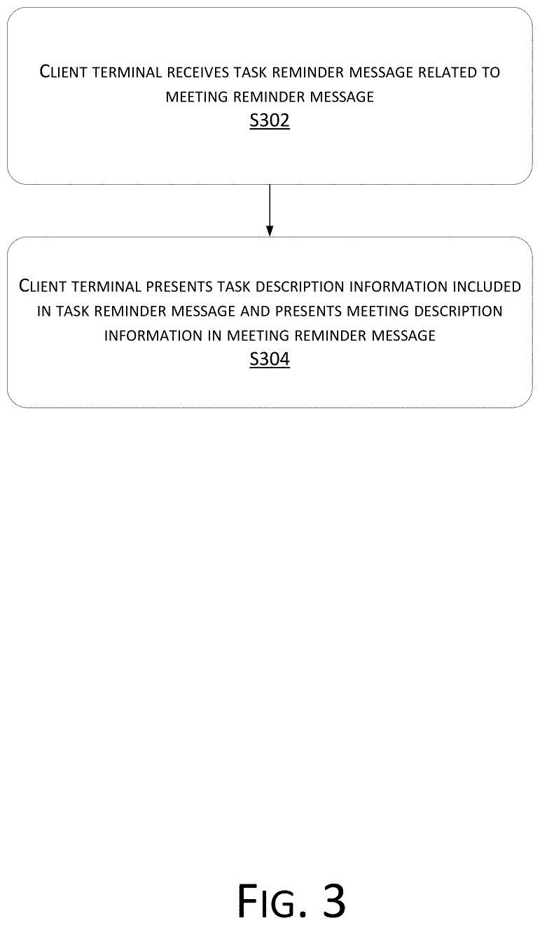

Correspondingly, FIG. 3 is a flowchart of a recipient-based task reminder method according to an exemplary embodiment of the present disclosure. As shown in FIG. 3, the method is applied to an electronic device of a recipient, which may include the following steps.

In step 302, a client terminal receives a task reminder message related to a meeting reminder message.

In step 304, the client terminal presents task description information included in the task reminder message and presents meeting description information in the meeting reminder message.

In this embodiment, when the task reminder message includes meeting description information, the client terminal may acquire the meeting description information included in the task reminder message and preset the meeting description information and task description information included in the task reminder message.

In this embodiment, the task reminder message may not include meeting description information. In an implementation mode, the task reminder message may include identification information of the meeting reminder message, and the client terminal may acquire corresponding meeting description information according to the identification information. For example, the client terminal may search historical reminder messages according to the identification information to search for the corresponding meeting reminder message and acquire meeting description information included in the meeting reminder message. For another example, the client terminal may initiate a query to the server terminal according to the identification information, so that the server terminal returns a corresponding meeting reminder message or meeting description information to the client terminal. In another implementation mode, the task reminder message may include a meeting association ID, so that the client terminal determines that the task reminder message has an associated meeting reminder message, and then the client terminal may initiate a query related to the task reminder message to the server terminal. If a sender client terminal informs the server terminal of an association between the task reminder message and the meeting reminder message in advance, the server terminal may determine the meeting reminder message based on the association, and then the client terminal may receive the meeting reminder message or meeting description information returned by the server terminal.

In this embodiment, the client terminal may present at least a part of the content of the meeting description information in a presentation area of the task reminder message. The presentation area may include a detail presentation interface specific to the task reminder message, or a presentation area corresponding to the task reminder message in the above reminder message management page.

In this embodiment, the client terminal may present at least a part of the content of the task description information in a presentation area of the meeting reminder message. The presentation area may include a detail presentation interface specific to the meeting reminder message, or a presentation area corresponding to the meeting reminder message in the above reminder message management page.

In this embodiment, the client terminal may display a first trigger option related to the meeting reminder message in a presentation area of the task reminder message, wherein the client terminal presents the meeting description information in the meeting reminder message when the first trigger option is triggered. When the client terminal has known the meeting description information, the first trigger option may include summary information of the meeting description information, and the client terminal may display detail information of the meeting description information based on the trigger operation for the first trigger option. The detail information may be presented in the presentation area of the task reminder message or presented in a separate interface (such as a detail presentation interface specific to the meeting reminder message or a temporary window interface). When the client terminal has not known the meeting description information yet, the first trigger option may include an indicative option such as “click to know the associated meeting,” and the client terminal may acquire the corresponding meeting description information for presentation based on the trigger operation for the first trigger option.

In this embodiment, the client terminal may display a second trigger option related to the task description information in a presentation area of the meeting reminder message, wherein the client terminal presents the task description information when the second trigger option is triggered. For example, the first trigger option may include summary information of the task description information, and the client terminal may display detail information of the task description information based on the trigger operation for the first trigger option. The detail information may be presented in the presentation area of the meeting reminder message or presented in a separate interface (such as a detail presentation interface specific to the task reminder message or a temporary window interface).

In this embodiment, the client terminal may perform task management on a task event corresponding to the task reminder message according to a trigger operation for the task event. For example, the task management may include pause, suspension and completion of the task event, which is not limited in the present disclosure. According to different permissions of logged-in users of the client terminal, the client terminal may implement different types of task management. The client terminal may not be able to implement task management when a logged-in user has no permission.

It should be noted that in addition to being applicable to a client terminal run on an electronic device of a recipient such as a mobile phone or a PC so that the client terminal implements functions such as receiving a task reminder message and presenting task description information and meeting description information, in some cases, the embodiment shown in FIG. 3 is also applicable to a server terminal so that the server terminal implements the functions such as receiving a task reminder message and presenting task description information and meeting description information to a recipient (such as sending task description information and meeting description information to a client terminal corresponding to the recipient) by running the steps included in the embodiment. Even in some cases, the embodiment shown in FIG. 3 may be further applied to other possible execution bodies, and the execution bodies implement the functions such as receiving a task reminder message and presenting task description information and meeting description information to a recipient by running the steps included in the embodiment, which is not limited in the present disclosure.

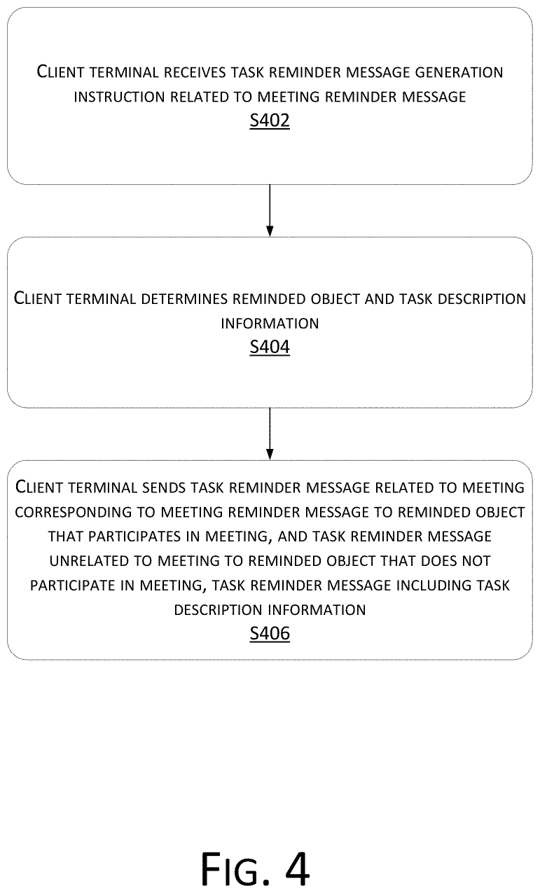

FIG. 4 is a flowchart of another sender-based task reminder method according to an exemplary embodiment of the present disclosure. As shown in FIG. 4, the method is applied to an electronic device of a sender, which may include the following steps.

In step 402, a client terminal receives a task reminder message generation instruction related to a meeting reminder message.

In this embodiment, the client terminal may provide many types of reminder messages. For example, a meeting reminder message is used for implementing a reminding function for a meeting event, and a task reminder message is used for implementing a reminding function for a task event. By setting corresponding types of the reminder messages, it is convenient for a user to classify different reminder messages for display and management, which is conducive to improving the reminding effect of the reminder messages and improving the event processing efficiency of the user.

In this embodiment, the client terminal may provide multiple ways of generating a task reminder message, so there are multiple ways of acquiring the above task reminder message generation instruction related to the meeting reminder message, which is not limited in the present disclosure. For example,

In an implementation mode, the client terminal may display a task creation option in a presentation interface of the meeting reminder message; and then the client terminal may determine that the task reminder message generation instruction is received when receiving a trigger operation for the task creation option. The presentation interface of the meeting reminder message includes any interface in which the meeting reminder message may be displayed, for example, a detail presentation interface specific to the meeting reminder message, or a reminder message management page for centralized display of the meeting reminder message and other reminder messages, and so on. Certainly, in addition to displaying a task creation option and performing a trigger operation on the task creation option by the user, the client terminal may also provide other triggering forms for the meeting reminder message, for example, draw a preset touch gesture on the above presentation interface, send a control voice, and so on, which is not limited in the present disclosure. In addition, the “task creation option” is only an option form that may be adopted, and another task-related function option may also be applied here to replace the “task creation option.” For example, the function option may be a “task editing option” or “task modification option.” When the “task editing option” or “task modification option” is triggered, a task reminder message template related to the meeting reminder message may be displayed to enable the sender to edit or modify the template to obtain a task reminder message related to the meeting reminder message.

In another implementation mode, the client terminal may receive a user creation operation for the task reminder message and a meeting binding operation for the task reminder message; and then the client terminal may determine that the task reminder message generation instruction related to the meeting reminder message is received when the meeting reminder message is selected by the meeting binding operation. For example, the client terminal may provide the user with a user creation operation for the task reminder message, and when the user triggers the creation option through the user creation operation, the client terminal may further provide the user with an alternative meeting reminder message (such as meeting reminder messages that have been received and sent by the client terminal) to allow the user to select, through a user selection operation, a meeting reminder message that the user wants to bind to the task reminder message.

In step 404, the client terminal determines a reminded object and task description information.

In step 406, the client terminal sends a task reminder message related to a meeting corresponding to the meeting reminder message to a reminded object that participates in the meeting and a task reminder message unrelated to the meeting to a reminded object that does not participate in the meeting, the task reminder message including the task description information.

In this embodiment, the reminded object may include at least one of the following: a participant of a meeting corresponding to the meeting reminder message, and an object that is selected by an object selection operation received by the client terminal. Therefore, the reminded object may include participants of the meeting and non-participants of the meeting. For the participants of the meeting, a task reminder message related to the meeting is sent to facilitate the participants of the meeting to associatively view and process the meeting and a task. For the non-participants of the meeting, a task reminder message unrelated to the meeting is sent so that the non-participants of the meeting are unconscious of the meeting, thereby avoiding confusion and helping to avoid the leakage of content of the meeting.

In this embodiment, for the “task reminder message related to the meeting,” after receiving the task reminder message, a recipient client terminal may present meeting description information of the meeting while presenting task description information to a recipient, so that the recipient associatively view and process the task and the meeting conveniently. In an implementation mode, the task reminder message may include meeting description information in the meeting reminder message, that is, the client terminal may add at least one piece of meeting description information in the meeting reminder message to the task reminder message to present it to the recipient. In another implementation mode, the task reminder message may not include the meeting description information. For example, in one case, the task reminder message may include identification information of the meeting reminder message, so that after receiving the task reminder message, the recipient client terminal may acquire at least one piece of corresponding meeting description information from the server terminal based on the identification information, or search for the corresponding meeting reminder message and meeting description information thereof in historical reminder messages of the recipient client terminal based on the identification information. In another case, the client terminal may inform the server terminal of association information between the task reminder message and the meeting reminder message, and the task reminder message may include a meeting association ID. The meeting association ID may indicate to the recipient client terminal that the task reminder message has an associated meeting reminder message, and the recipient client terminal may initiate an inquiry to the server terminal, so that the server terminal returns at least one piece of meeting description information of the corresponding meeting reminder message to the recipient client terminal based on the above association information.

In this embodiment, for the “task reminder message unrelated to the meeting,” when receiving the task reminder message, the recipient client terminal may present task description information to the recipient, just like the task reminder message in conventional techniques.

In this embodiment, when the reminded object does not participate in a meeting corresponding to the meeting reminder message, the reminded object is equivalent to being independent of the participants of the meeting, so the reminded object may have a task management permission for the task reminder message to determine the task processing status of the reminded object and make the operation experience not different from the task reminder message in conventional techniques.

In this embodiment, when the reminded object participates in the meeting and is configured as a task leader, the reminded object may have a task management permission for the task reminder message. When the reminded object participates in the meeting and is configured as a task participant, the reminded object may not have a task management permission for the task reminder message. In this case, the task leader and the task participant are equivalent to a whole, and the task leader implements a unified task management operation on behalf of the whole.

It should be noted that in addition to being applicable to a client terminal run on an electronic device of a sender such as a mobile phone or a PC so that the client terminal implements functions such as generating and sending a task reminder message, in some cases, the embodiment shown in FIG. 4 is also applicable to a server terminal so that the server terminal implements the functions such as generating and sending a task reminder message by running the steps included in the embodiment. Even in some cases, the embodiment shown in FIG. 4 may be further applied to other possible execution bodies, and the execution bodies implement the functions such as generating and sending a task reminder message by running the steps included in the embodiment, which is not limited in the present disclosure.

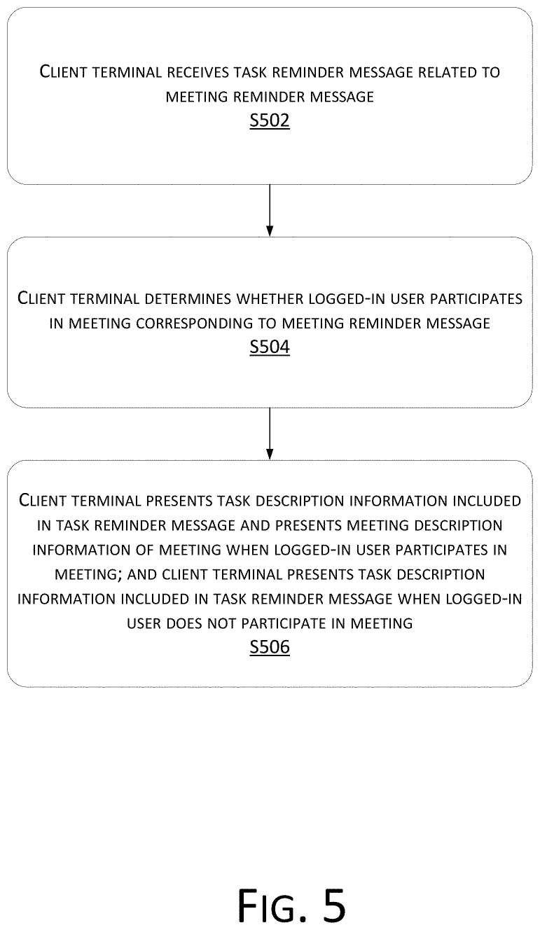

Correspondingly, FIG. 5 is a flowchart of another recipient-based task reminder method according to an exemplary embodiment of the present disclosure. As shown in FIG. 5, the method is applied to an electronic device of a recipient, which may include the following steps.

In step 502, a client terminal receives a task reminder message related to a meeting reminder message.

In step 504, the client terminal determines whether a logged-in user participates in a meeting corresponding to the meeting reminder message.

In step 506, the client terminal presents task description information included in the task reminder message and presents meeting description information of the meeting when the logged-in user participates in the meeting; and the client terminal presents the task description information included in the task reminder message when the logged-in user does not participate in the meeting.

In this embodiment, a sender client terminal may send a task reminder message related to the meeting reminder message to all reminded objects, and a client terminal at the recipient determines corresponding presentation content according to a meeting participation status of the logged-in user (i.e., the recipient), which is conducive to simplifying the processing procedure of the sender client terminal and improving the communication efficiency.

In this embodiment, when the logged-in user participates in the meeting, the client terminal may present task description information and meeting description information. In an embodiment, when the task reminder message includes meeting description information, the client terminal may acquire the meeting description information included in the task reminder message and present the meeting description information and task description information included in the task reminder message. In another embodiment, the task reminder message may not include meeting description information. In one case, the task reminder message may include identification information of the meeting reminder message, and the client terminal may acquire corresponding meeting description information according to the identification information. For example, the client terminal may search historical reminder messages according to the identification information to search for the corresponding meeting reminder message and acquire meeting description information included in the meeting reminder message. For another example, the client terminal may initiate a query to the server terminal according to the identification information, so that the server terminal returns a corresponding meeting reminder message or meeting description information to the client terminal. In another case, the task reminder message may include a meeting association ID, so that the client terminal determines that an associated meeting reminder message exists in the task reminder message, and then the client terminal may initiate a query related to the task reminder message to the server terminal. If a sender client terminal informs the server terminal of an association between the task reminder message and the meeting reminder message in advance, the server terminal may determine the meeting reminder message based on the association, and then the client terminal may receive the meeting reminder message or meeting description information returned by the server terminal.

In this embodiment, the client terminal may present at least a part of the content of the meeting description information in a presentation area of the task reminder message. The presentation area may include a detail presentation interface specific to the task reminder message, or a presentation area corresponding to the task reminder message in the above reminder message management page.

In this embodiment, the client terminal may present at least a part of the content of the task description information in a presentation area of the meeting reminder message. The presentation area may include a detail presentation interface specific to the meeting reminder message, or a presentation area corresponding to the meeting reminder message in the above reminder message management page.

In this embodiment, the client terminal may display a first trigger option related to the meeting reminder message in a presentation area of the task reminder message, wherein the client terminal presents the meeting description information in the meeting reminder message when the first trigger option is triggered. When the client terminal has known the meeting description information, the first trigger option may include summary information of the meeting description information, and the client terminal may display detail information of the meeting description information based on the trigger operation for the first trigger option. The detail information may be presented in the presentation area of the task reminder message or presented in a separate interface (such as a detail presentation interface specific to the meeting reminder message or a temporary window interface). When the client terminal has not known the meeting description information yet, the first trigger option may include an indicative option such as “click to know the associated meeting,” and the client terminal may acquire the corresponding meeting description information for presentation based on the trigger operation for the first trigger option.

In this embodiment, the client terminal may display a second trigger option related to the task description information in a presentation area of the meeting reminder message, wherein the client terminal presents the task description information when the second trigger option is triggered. For example, the first trigger option may include summary information of the task description information, and the client terminal may display detail information of the task description information based on the trigger operation for the first trigger option. The detail information may be presented in the presentation area of the meeting reminder message or presented in a separate interface (such as a detail presentation interface specific to the task reminder message or a temporary window interface).

In this embodiment, the client terminal may perform task management on a task event corresponding to the task reminder message according to a trigger operation for the task event. For example, the task management may include pause, suspension and completion of the task event, which is not limited in the present disclosure. According to different permissions of logged-in users of the client terminal, the client terminal may implement different types of task management. The client terminal may not be able to implement task management when a logged-in user has no permission.

It should be noted that in addition to being applicable to a client terminal run on an electronic device of a recipient such as a mobile phone or a PC so that the client terminal implements functions such as receiving a task reminder message and presenting task description information and meeting description information, in some cases, the embodiment shown in FIG. 5 is also applicable to a server terminal so that the server terminal implements the functions such as receiving a task reminder message and presenting task description information and meeting description information to a recipient (such as sending task description information and meeting description information to a client terminal corresponding to the recipient) by running the steps included in the embodiment. Even in some cases, the embodiment shown in FIG. 5 may be further applied to other possible execution bodies, and the execution bodies implement the functions such as receiving a task reminder message and presenting task description information and meeting description information to a recipient by running the steps included in the embodiment, which is not limited in the present disclosure.

As may be seen from the above technical solution, according to the present disclosure, a task reminder message is associated with a meeting reminder message, so that a user may quickly view related information of an associated meeting in the process of task processing, which helps improve the efficiency of task processing.

For ease of understanding, the technical solution of the present disclosure is described below by taking an enterprise instant messaging application as an example. Assuming that an enterprise instant messaging application's client terminal is run on a mobile phone 13, a mobile phone 14 and a mobile phone 15, and an enterprise instant messaging application's server terminal is run on a server 11. Registered accounts of different users are logged in at the enterprise instant messaging application's client terminal on the mobile phones 13-15 respectively. For example, a registered account A (i.e., a user A) of a sender is logged in on the mobile phone 13, so that the mobile phone 13 is configured as a sender device corresponding to the sender. An enterprise instant messaging application's client terminal 1 corresponding to the initiator is logged in on the mobile phone 13, and a registered account B (i.e., a user B) and a registered account C (i.e., a user C) of recipients are logged in on the mobile phones 14-15 respectively, so that the mobile phones 14-15 are configured as recipient devices corresponding to the two recipients. An enterprise instant messaging application's client terminal 2 and an enterprise instant messaging application's client terminal 3 corresponding to the two recipients are logged in on the mobile phones 14-15. The user A may create a task reminder message related to a meeting reminder message on the mobile phone 13 and send the task reminder message to the user B and the user C to implement task reminder for the user B and the user C. The technical solution of the present disclosure is described in detail below based on the process.

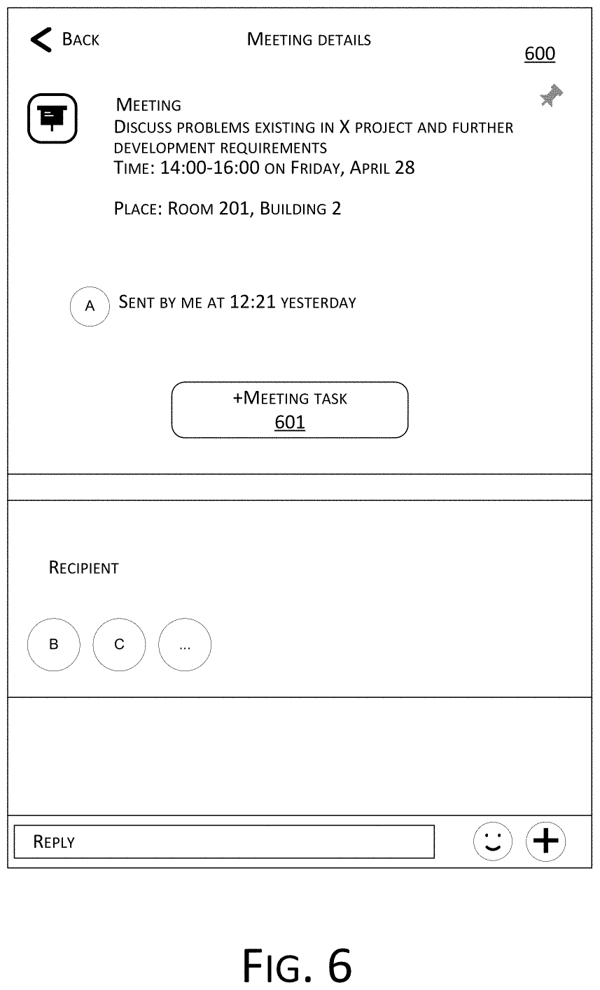

FIG. 6 shows a meeting detail interface 600 of the enterprise instant messaging application's client terminal 1 on the mobile phone 13. The meeting details interface 600 is used for presenting details of meeting description information of the meeting reminder message, for example, the meeting theme “discuss problems existing in the X project and further development requirements,” the meeting time “14:00-16:00 on Friday, April 28,” the meeting place “Room 201, Building 2,” a sender A (that is, “I”) of the meeting reminder message, the sending time “12:21 yesterday,” and so on. These are the same as the presentation of the meeting description information in conventional techniques.

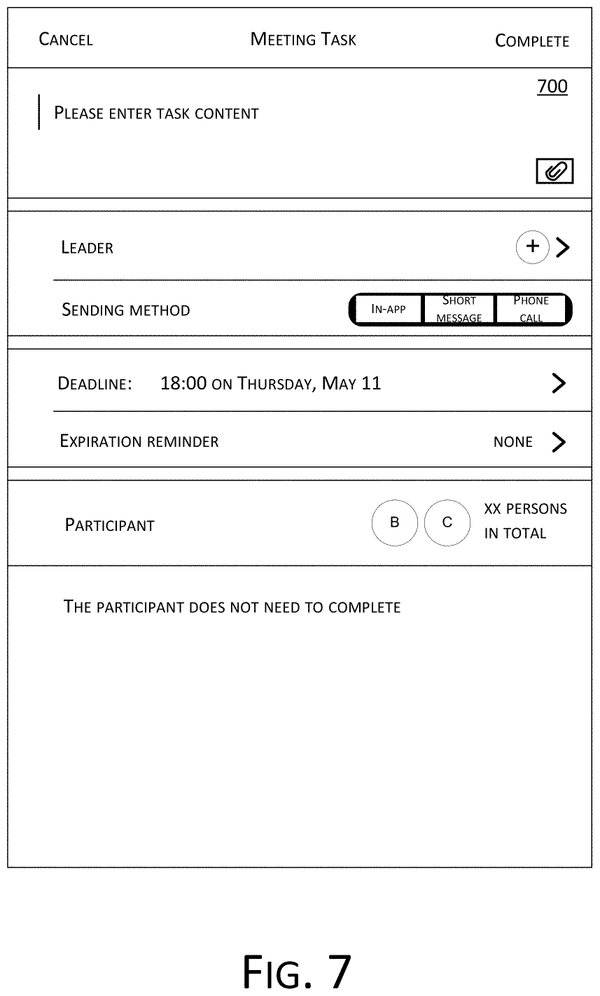

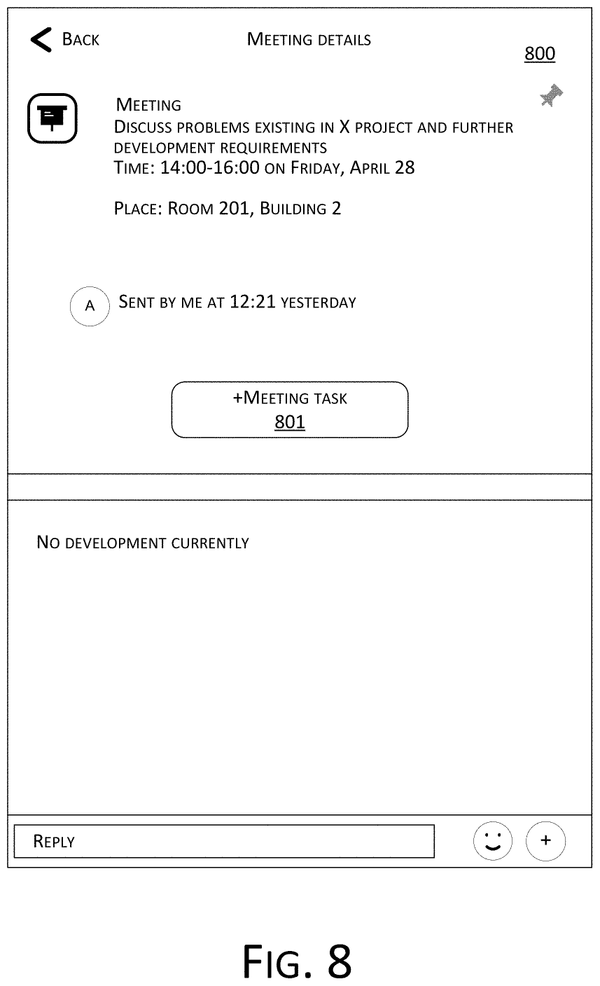

The meeting detail interface 600 of the present disclosure further includes a meeting task creation option 601. When the user A triggers the meeting task creation option 601 by clicking or other methods, the enterprise instant messaging application's client terminal 1 may determine that the user A needs to create a task reminder message related to the meeting reminder message shown in FIG. 6, that is, a “meeting task.” For example, the enterprise instant messaging application's client terminal 1 may present a meeting task creation interface 700 shown in FIG. 7 to allow the user A to create the above meeting task. Certainly, in addition to the creator A of the meeting reminder message, other meeting participants may also create a task reminder message related to the meeting reminder message. For example, as shown in FIG. 8, a meeting detail interface 800 shown on the enterprise instant messaging application's client terminal 2 of the mobile phone 14 (or the enterprise instant messaging application's client terminal 3 of the mobile phone 15, etc.) may include a meeting task creation option 801. When the enterprise instant messaging application's client terminal 2 detects a trigger operation of the user B for the meeting task creation option 801, the enterprise instant messaging application's client terminal 2 may present the meeting task creation interface 700 shown in FIG. 7 to allow the user B to create a corresponding meeting task.

For example, the user A operates the meeting task creation interface 700 shown in FIG. 7, and the user A may input task description information of the meeting task through the meeting task creation interface 700. For example,

The task description information may include a task theme, and the user A may input the task theme through an input box in the meeting task creation interface 700 where “please enter task content” is presented. Certainly, the task theme may further include voice, video, picture, document and other content, and is not only limited to literal content input into the input box by the user A.

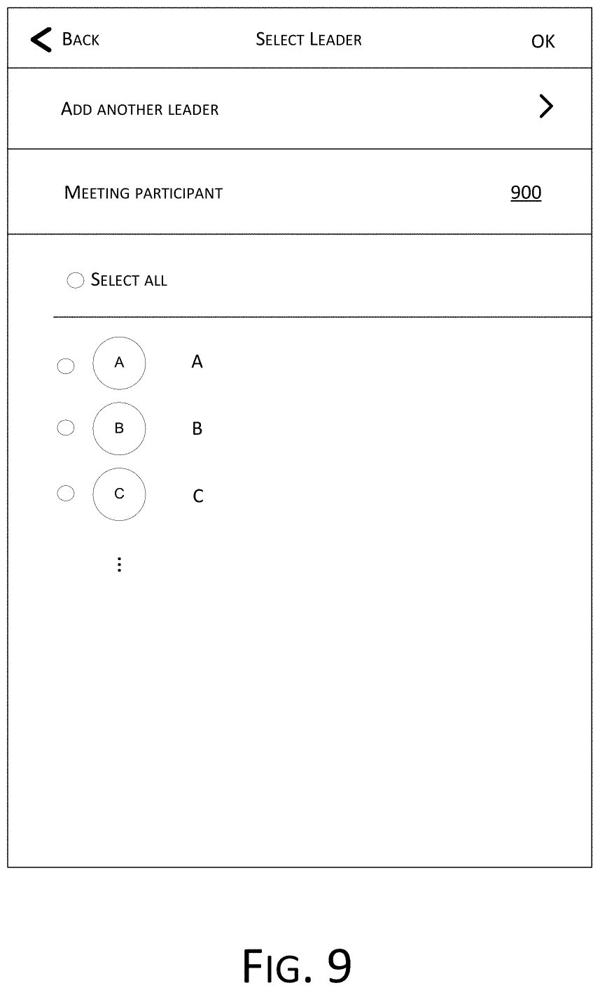

The task description information may include a task leader. The user A may select a leader of the meeting task by triggering the “leader” option in the meeting task creation interface 700. For example, the enterprise instant messaging application's client terminal 1 may present a leader selection interface 900 shown in FIG. 9 and determine a corresponding task leader according to an operation of the user A on the leader selection interface 900. As shown in FIG. 9, the enterprise instant messaging application's client terminal 1 may display a participant of a meeting (i.e., “meeting participant”) corresponding to the above meeting reminder message. Certainly, the user A may also select another person not participating in the meeting as a task leader by triggering the “add another leader” option.

The task description information may include a sending method. The user A may select a sending method of the meeting task by triggering “in-app,” “short message,” “phone call” and other options in the meeting task creation interface 700. The “in-app” indicates that the enterprise instant messaging application's client terminal 1 will send the meeting task through an instant messaging technology, the “short message” indicates that the enterprise instant messaging application's client terminal 1 will send the meeting task through a short message, and the “phone call” indicates that the enterprise instant messaging application's client terminal 1 will initiate a call and play a task theme and other task description information after connection. The user A may select one or more of the “in-app,” “short message,” “phone call” and other options, so that the enterprise instant messaging application's client terminal 1 sends the meeting task in one or more corresponding methods.

The task description information may include a task deadline. The user A may set the deadline of the meeting task by triggering the “deadline” option in the meeting task creation interface 700, such as “18:00 on Thursday, May 11,” as shown in FIG. 7.

The task description information may include an expiration reminding function. The user A may set whether it is necessary to implement an expiration reminder for the meeting task by triggering the “expiration reminder” option in the meeting task creation interface 700. When it is necessary to implement the expiration reminder, an expiration reminding method (such as “in-app,” “short message,” and “phone call”) and time (such as “3 days before expiration”) may be further set.

The task description information may include task participants. The user A may select task participants of the meeting task by triggering the “participant” option in the meeting task creation interface 700. The task participants and the task leader all may receive the meeting task, but, as indicated by “participants do not need to complete” shown in FIG. 7, when the task participants and the task leader are all meeting participants, the task leader has a permission of implementing a “complete operation” on the meeting task, while the task participants do not have the permission, which will be described in detail below.

When detecting that the user A triggers the “complete” option in the upper right corner of the meeting task creation interface 700, the enterprise instant messaging application's client terminal 1 may send the above meeting task to the user B, the user C, and so on. It should be noted that in the technical solution of the present disclosure, the creation time and the sending time of the meeting task are irrelevant to the proceeding of the meeting. In other words, the operation of creating or sending the meeting task may be implemented before the meeting, during the meeting, after the meeting or at any other time, which is not limited in the present disclosure.

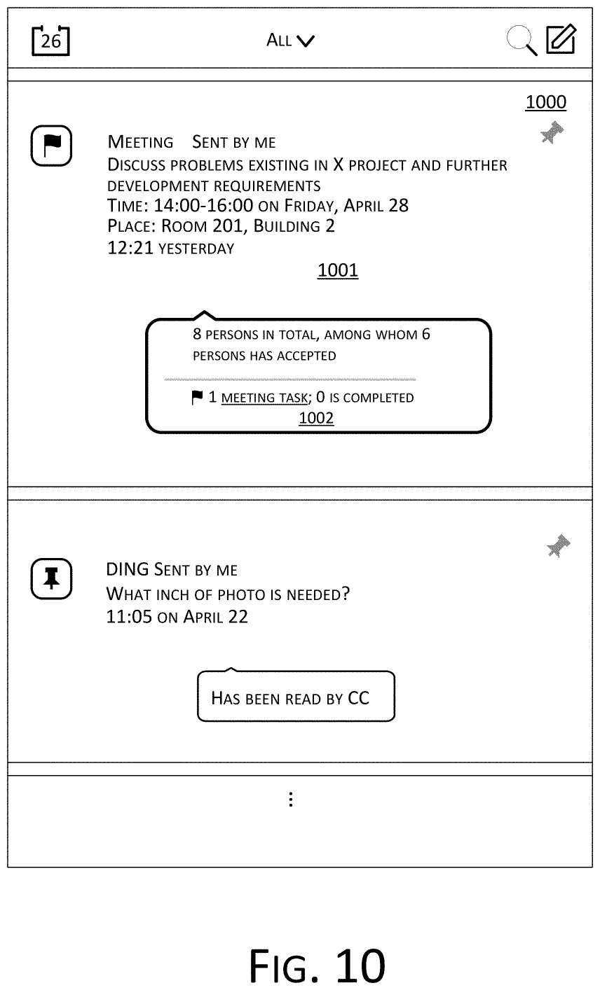

For the user A, after the enterprise instant messaging application's client terminal 1 sends the meeting task, the sent meeting task may be displayed in a reminder message management interface 1000 shown in FIG. 10. At the same time, the reminder message management interface 1000 is further used for centrally presenting other reminder messages sent or received by the user A. In the reminder message management interface 1000, the above meeting task is presented in a presentation area 1001 corresponding to the meeting task, and the presentation area 1001 further includes a presentation content 1002 related to the above meeting task to establish an association between the meeting reminder message and the meeting task.

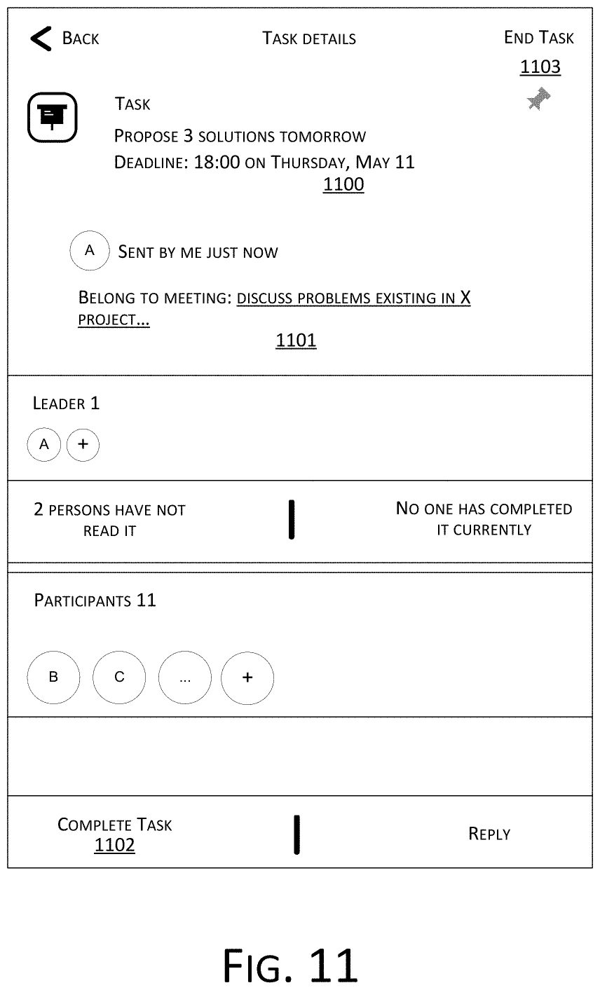

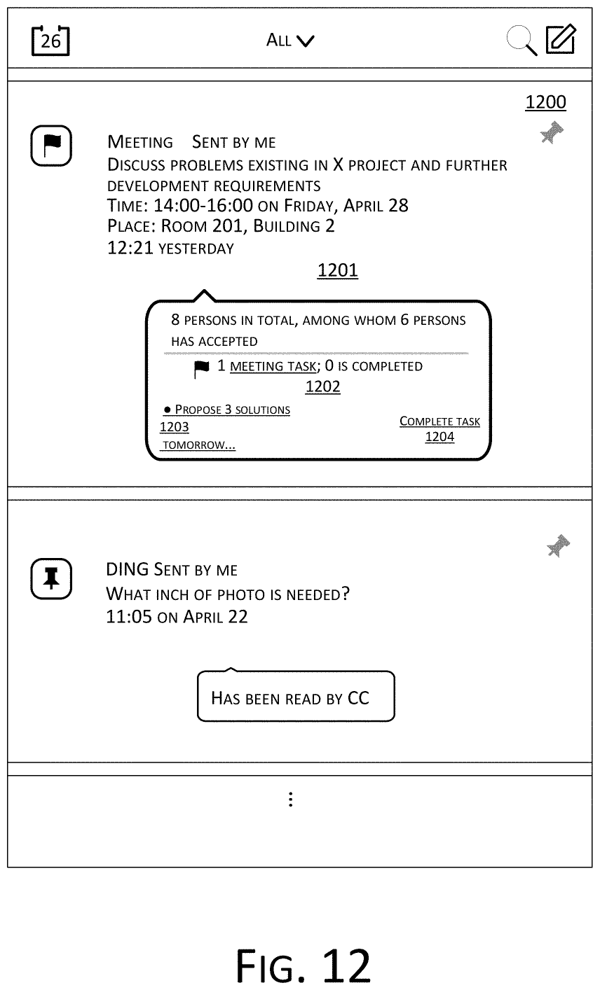

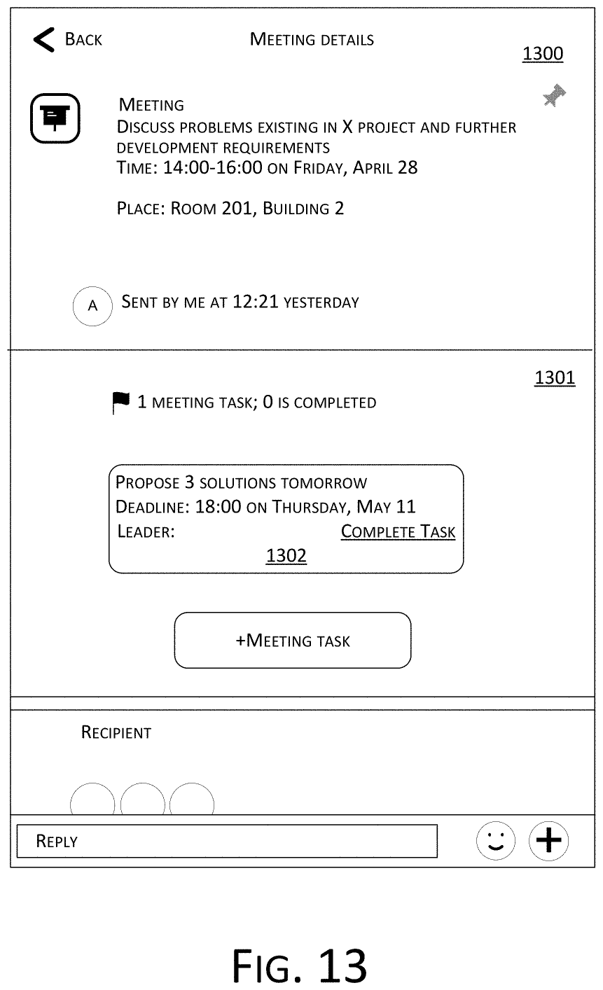

As shown in FIG. 10, the presentation content 1002 may include “1 meeting task; 0 is completed” to indicate that the corresponding meeting reminder message has an associated meeting task. When a trigger operation for the presentation content 1002 is detected, the enterprise instant messaging application's client terminal 1 may display a task details interface 1100 shown in FIG. 11 to present task description information of the meeting task in detail. The task details interface 1100 includes a task “Propose 3 solutions tomorrow” and “Deadline: 18:00 on Thursday, May 11.” The task details interface 1100 may also present information indicating that the task is associated with a specific meeting, such as “belong to meeting: discuss problems existing in X project . . . ” 1101 as shown in FIG. 11. Certainly, in other embodiments, for example, in a presentation area 1201 corresponding to the meeting reminder message in the reminder message management interface 1200 shown in FIG. 12, in addition to “1 meeting task; 0 is completed” or similar prompt information 1202, the presentation content corresponding to the meeting task may further include summary information 1203 of the task description information of the meeting task. For example, the summary information 1202 may include “⋅ propose 3 solutions tomorrow . . . ” etc., which may reduce the occupation of the presentation area 1201 for the reminder message management interface 1200 (in order to show more remind messages on the mobile phone 13 at the same time), and may also prompt the task description information of the meeting task to the user A to some extent, so that the user A does not need to enter the task details interface 1100 shown in FIG. 11 in some cases. Certainly, if a trigger operation for the prompt information 1202 or the summary information 1203 is detected, the enterprise instant messaging application's client terminal 1 still may present the task details interface 1100 shown in FIG. 11 to facilitate the user A to view. In other embodiments, for example, in a presentation area 1301 corresponding to the meeting reminder message in a reminder message management interface 1300 shown in FIG. 13, the presentation content corresponding to the meeting task may include detail information of the task description information.

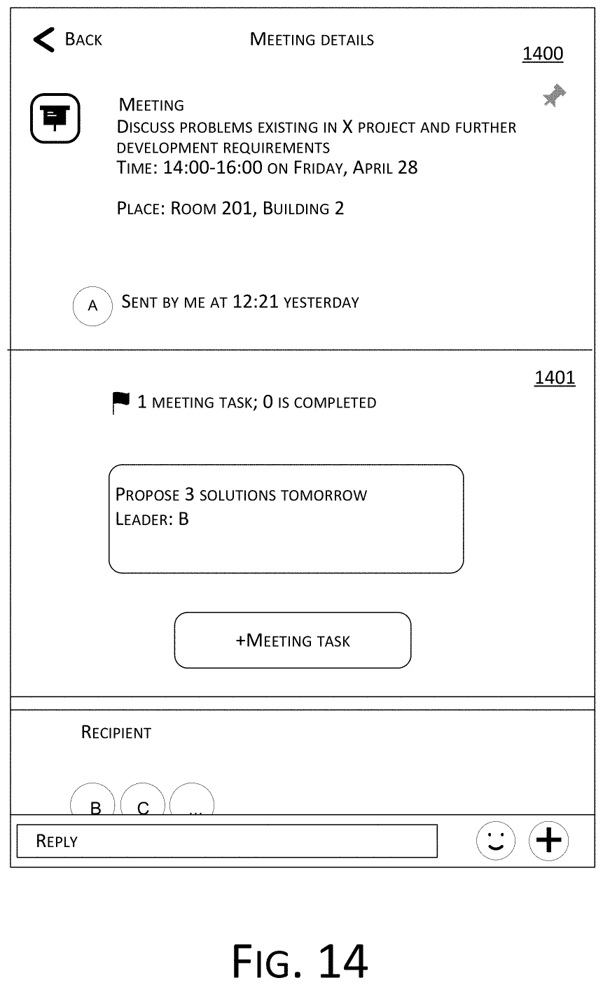

In the embodiment shown in FIG. 11 to FIG. 13, the user A is a leader of the meeting task, and thus the user A has a management permission for the meeting task. For example, as shown in FIG. 11, the task details interface 1100 may include a “complete task” option 1102. When a trigger operation for the option 1102 is detected, the enterprise instant messaging application's client terminal 1 may implement a “complete task” management operation for the meeting task. Similarly, the reminder message management interface 1200 shown in FIG. 12 may include a “complete task” option 1204, the reminder message management interface 1300 shown in FIG. 13 may include a “complete task” option 1302, and the enterprise instant messaging application's client terminal 1 may implement a “complete task” management operation on the meeting task according to a trigger operation of the user A for the option 1204 or the option 1302. In the embodiment shown in FIG. 14, when the leader of the meeting task is the user B instead of the user A, the user A does not have a management permission for the meeting task. Thus, in a reminder message management interface 1400 shown in FIG. 14, the enterprise instant messaging application's client terminal 1 may display related content of the meeting task in a presentation area 1401 of the meeting reminder message but does not display the above “complete task” option, so that the user A cannot implement a “complete task” management operation for the meeting task.

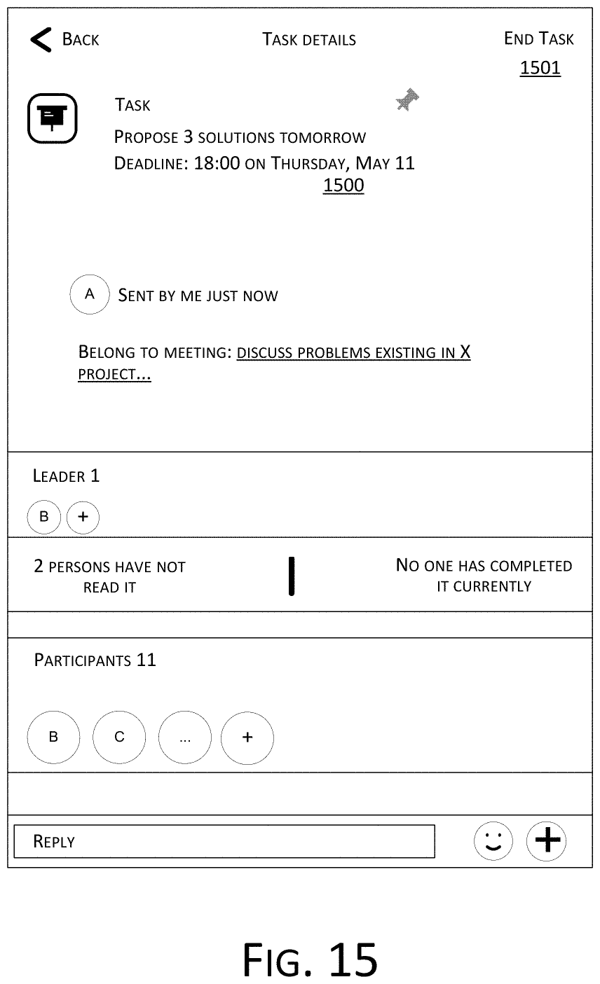

When the user A is a creator of the above meeting task, the task details interface 1100 shown in FIG. 11 may include an “end task” option 1103 for the meeting task, so that when the user A triggers the option 1103, the enterprise instant messaging application's client terminal 1 may terminate the meeting task. The “terminate task” permission of the user A over the meeting task is related to the identity of the user A as a creator. Thus, as shown in FIG. 15, even if the user A is not the leader of the meeting task, a task details interface 1500 shown in FIG. 15 still may include an “end task” option 1501 to allow the user A to terminate the meeting task.

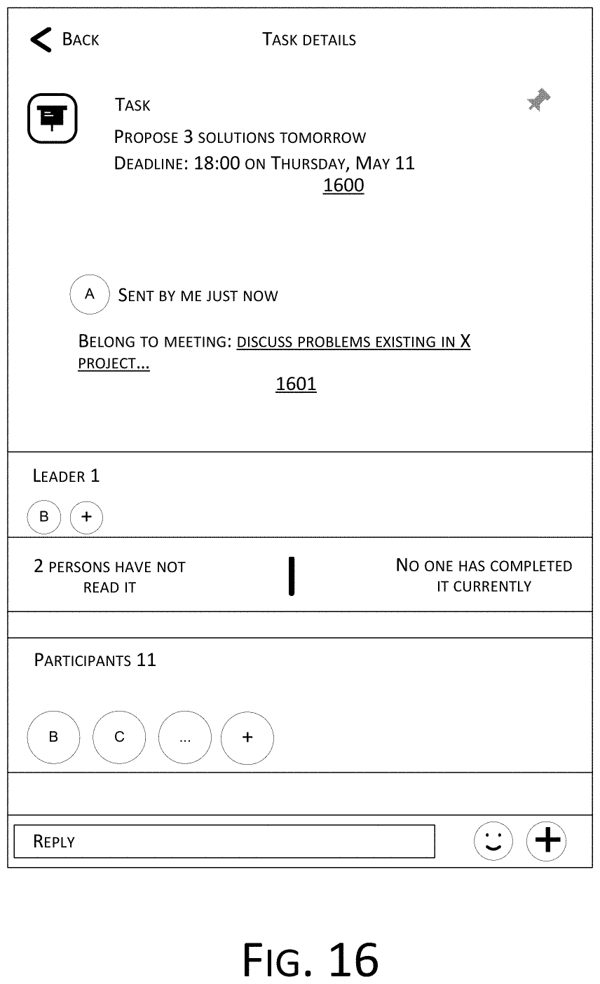

For a task details interface 1600 displayed by the enterprise instant messaging application's client terminal 3 shown in FIG. 16, the user C serves as a meeting participant and a participant of the meeting task, and the task details interface 1600 may display a content 1601 related to the meeting “discuss problems existing in the X project . . . ” However, as the user C is not the leader of the above meeting task, the task details interface 1600 does not display the “complete task” option, that is, the user C does not have a “complete task” permission for the meeting task. Similarly, as the user C is not the creator of the meeting task, the task details interface 1600 does not display the “end task” option, that is, the user C does not have an “end task” permission for the meeting task.

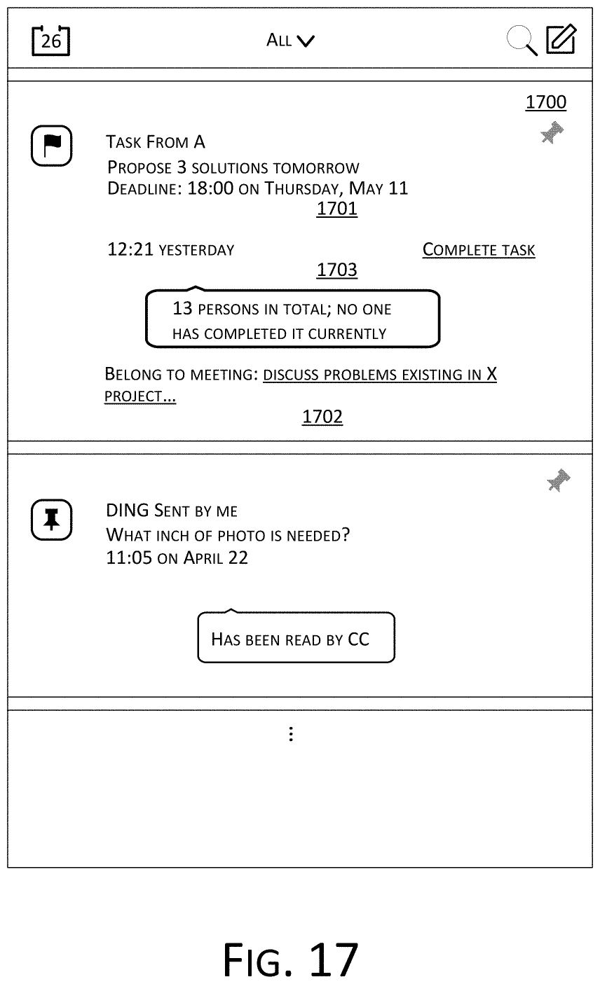

The above meeting task may serve as a relatively separate task reminder message to be managed by the enterprise instant messaging application's client terminal. For example, as shown in FIG. 17, in a reminder message management interface 1700 displayed by the enterprise instant messaging application's client terminal 2, task description content of the above meeting task may be presented in a presentation area 1701 in the reminder message management interface 1700, and the presentation area 1701 may further include a prompt content 1702 related to the above meeting reminder message (that is, to the corresponding meeting), for example, the prompt content 1702 may include “belong to a meeting: discuss problems existing in the X project,” and so on. At the same time, when the user B is a leader of the meeting task, the presentation area 1701 may further include a “complete task” option 1703, so that the user B may implement a “complete task” operation for the meeting task by triggering the option 1703.

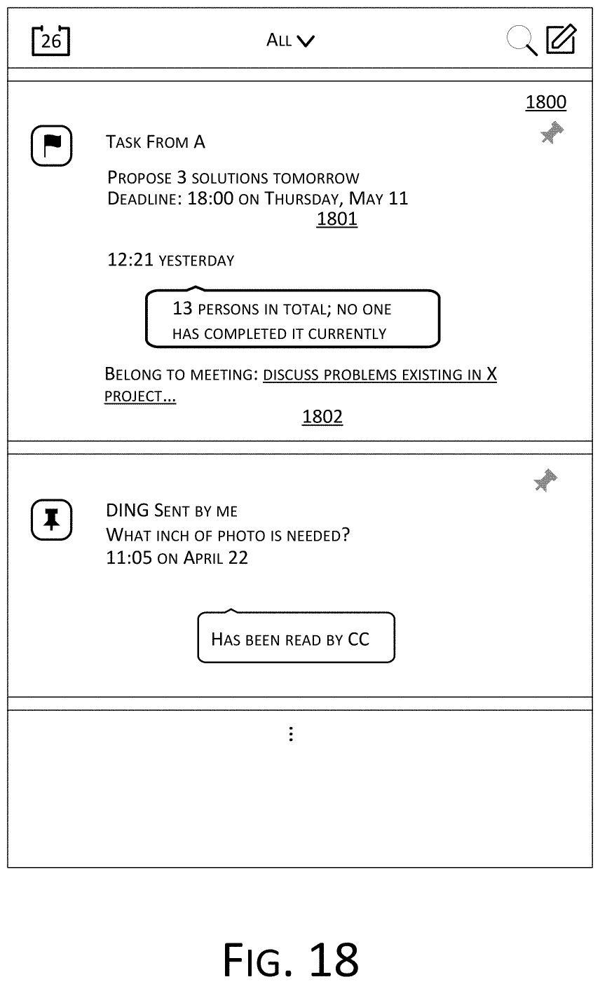

For the user C who is not the leader, in a reminder message management interface 1800 displayed by the enterprise instant messaging application's client terminal 3 shown in FIG. 18, task description content of the above meeting task may be presented in a presentation area 1801 in the reminder message management interface 1800, and the presentation area 1801 may further include a prompt content 1802 related to the above meeting reminder message (that is, to the corresponding meeting), but does not include a “complete task” option.

A participant of the meeting task does not need to manage the meeting task, and thus the meeting task may be used as an attaching message (which may be embodied as “task follow-up” shown in FIG. 18, as opposed to the “task” shown in FIG. 17) of the above meeting reminder message, instead of a normal task reminder message, so that the attaching message cannot be presented in the reminder message management interface 1800 shown in FIG. 18 and may only be indirectly called through the above meeting reminder message. For example, the user C may find the meeting reminder message in the reminder message management interface 1800. Related content (similar to the presentation content 1002 shown in FIG. 10) of the meeting task may be included in the presentation area of the meeting reminder message, and the user C may enter the task details interface 1600 as shown in FIG. 16 through the related content to view the corresponding task description information in detail.

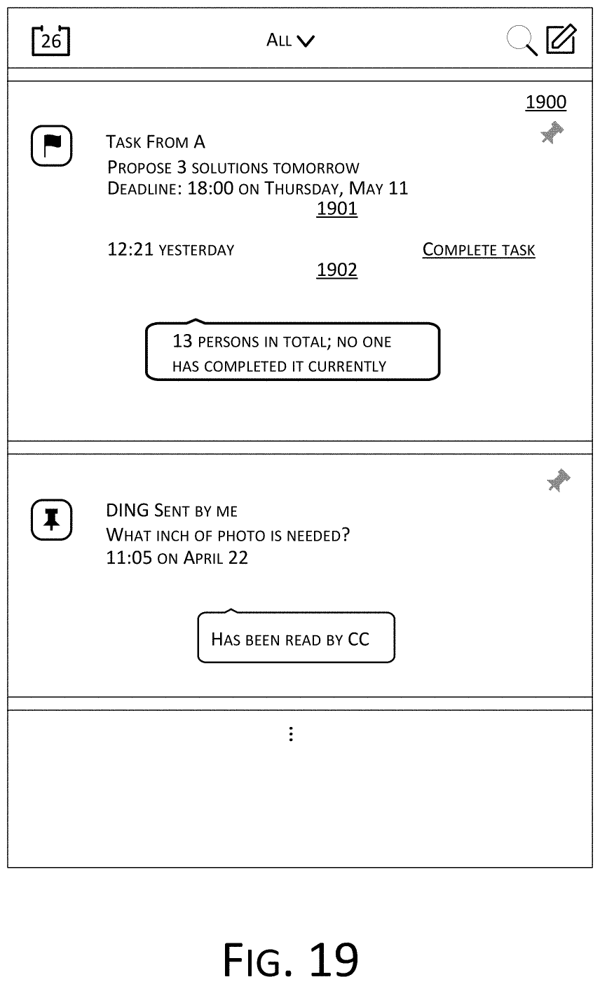

In addition, the participant of the meeting task may not be a meeting participant of the above meeting, and then in a reminder message management interface 1900 shown in FIG. 19 displayed by the corresponding enterprise instant messaging application's client terminal, task description information of the meeting task may be normally presented in a corresponding presentation area 1901, and the presentation area 1901 may further include a “complete task” option 1902, that is, the participant has a “complete task” permission for the meeting task. In other words, for the participant, the meeting task is not different from other task reminder messages in conventional techniques.

In the above various embodiments, a task reminder message is associated with a meeting reminder message, so that after receiving the task reminder message, a recipient client terminal may present meeting description information of the meeting reminder message related to the task reminder message to facilitate easy viewing of a recipient. In the following embodiment, the task reminder message may also be associated with a meeting event, which may also cause a recipient of the task reminder message to present meeting description information of the meeting.

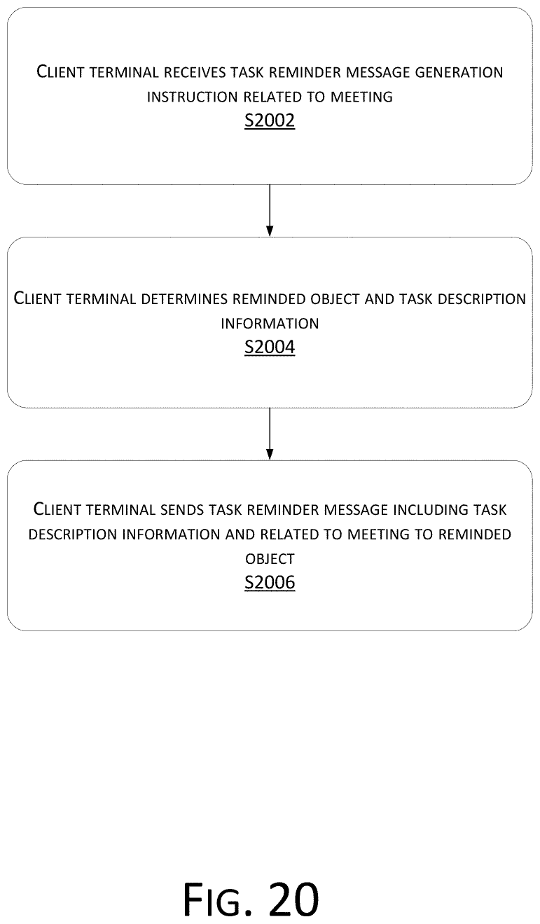

FIG. 20 is a flowchart of still another sender-based task reminder method according to an exemplary embodiment of the present disclosure. As shown in FIG. 20, the method is applied to an electronic device of a sender, which may include the following steps.

In step 2002, a client terminal receives a task reminder message generation instruction related to a meeting.

In this embodiment, a meeting reminder message is used for implementing a reminding function for a meeting event, and the client terminal may further implement other functions related to the meeting event. Thus, the client terminal may enable a recipient client terminal to acquire and present corresponding meeting description information by associating the task reminder message with a meeting (i.e., the meeting event).

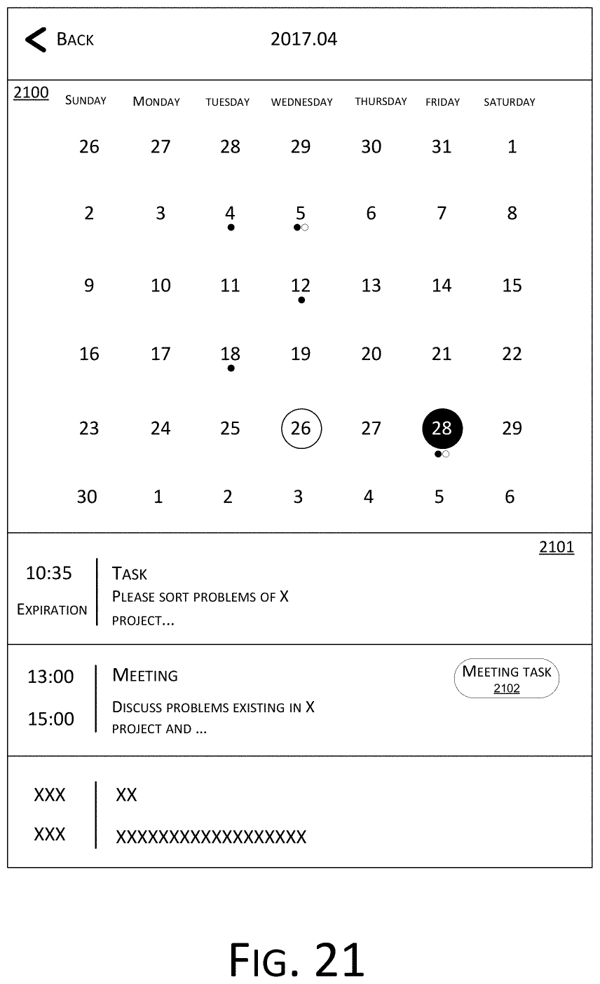

For example, in the enterprise instant messaging application's client terminal of the present disclosure, in order to facilitate the implementation of enterprise matters management inside an enterprise, a management calendar function may be provided. For example, as shown in FIG. 21, a user may quickly grasp the processing status of enterprise matters when a management calendar 2100 is displayed and enterprise matters associated to everyday is displayed on the management calendar 2100, thus facilitating the reasonable arrangement of the subsequent work. By taking the management calendar 2100 shown in FIG. 21 as an example, the user may quickly know that the corresponding date has an associated enterprise matter when event prompt information is added to the date having an enterprise matter. For example, a black dot is added at the bottom of “Apr. 4, 2017,” “Apr. 5, 2017,” “Apr. 12, 2017,” and “Apr. 18, 2017,” respectively to indicate the existence of a task event. A white dot existing at the bottom of “Apr. 5, 2017” and “Apr. 28, 2017,” indicate that there is a meeting event on that day. Certainly, other types of events may also be represented in other manners.

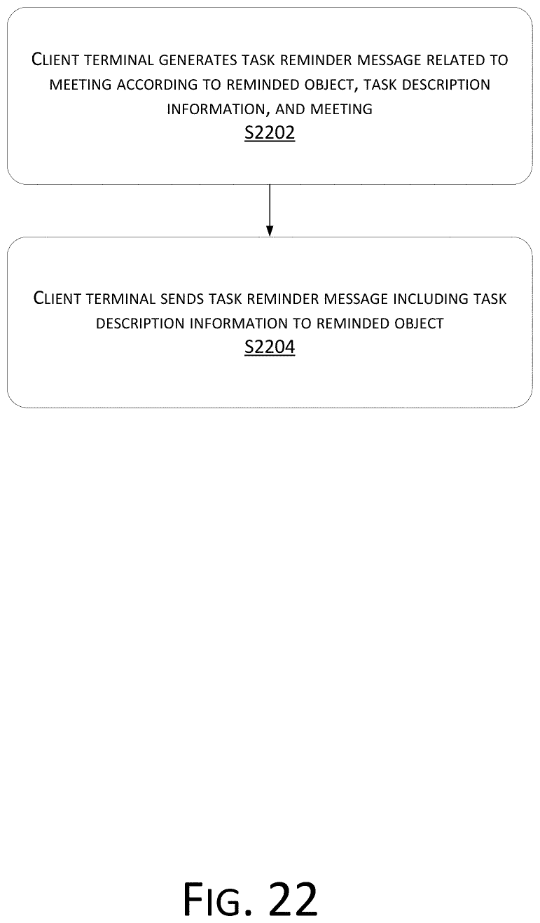

When it is detected that a certain date is selected, for example, assuming that “Apr. 28, 2017” in FIG. 21 is selected, enterprise matters existing during that date may be displayed. For example, description information of a task event (corresponding to the black dot at the bottom of “28”) and a meeting event (corresponding to the white dot at the bottom of “28”) existing on “Apr. 28, 2017” may be displayed in a presentation area 2101 in a lower part of the management calendar 2100. The description information may be summary information shown in FIG. 22 (when a certain piece of summary information is selected, corresponding details may be further displayed), or the description information may be detail information. When “Apr. 28, 2017” is selected, the corresponding number “28” may be highlighted to be distinguished from other dates. For example, the manner of adjusting the number 28 to white and adding a black background is used in FIG. 21. At the same time, the current date may also be highlighted in a manner of being distinguished from the selected date and other dates, for example, a ring may be added to the periphery of “Apr. 26, 2017.”

When an enterprise matter existing during the selected date is presented, type prompt information for the enterprise matter may be displayed, such as the word “task” corresponding to the task event shown in FIG. 21, and the word “meeting” corresponding to the meeting event. In addition, the type prompt information may also be matched with enterprise matter prompt information such as the above black dot and the white dot in the management calendar. For example, identical or similar presentation attributes are adopted for the type prompt information and the enterprise matter prompt information, so that the user may obtain an association between them from the visual perception, which is conducive to improving user experience. For example, the presentation attributes may include color, grayscale, transparency, and so on, which is not limited in the present disclosure.

By taking the meeting event shown in FIG. 21 as an example, a “meeting task” option 2102 may be displayed in an associated area of the meeting event. When a trigger operation for the option 2102 is detected, it may be determined that a task reminder message generation instruction related to a meeting event “discuss problems existing in the X project to . . . ” shown in FIG. 21 is received to create a task reminder message (i.e., meeting task) related to the meeting.

Certainly, the option 2102 may also be in other forms, such as “task creation,” “task editing,” and “task modification,” which is not limited in the present disclosure. For example, when the form such as “task editing” or “task modification” is adopted and when the “task editing” or “task modification” option is triggered, a task reminder message template related to the meeting may be displayed to allow the sender to edit or modify the template, and then a task reminder message related to the meeting may be obtained.

In step 2004, the client terminal determines a reminded object and task description information.

In this embodiment, the reminded object may include at least one of the following: a participant of the meeting, and an object that is selected by an object selection operation received by the client terminal. In an implementation mode, the client terminal may present the participant of the meeting and an associated user of the sender as alternative users to allow the sender to select a sender-wanted user to serve as the reminded object. In another implementation mode, the client terminal may take the participant of the meeting as the reminded object by default and present the associated user of the sender as an alternative user for presentation to allow the sender to further add the sender-wanted user to serve as the reminded object. In one case, the participant of the meeting may be set to be required as the reminded object, and in the other case, although the participant of the meeting is added as the reminded object by default, the sender may make adjustment according to an actual situation.

In step 2006, the client terminal sends a task reminder message including the task description information and related to the meeting to the reminded object.

In an embodiment, the task reminder message may further include meeting description information of the meeting, that is, the client terminal may add at least one piece of meeting description information in the meeting reminder message to the task reminder message to present it to a recipient. The meeting description information may come from many sources. For example: in the embodiment shown in FIG. 21, meeting description information of a meeting event may be recorded in the management calendar 2100, so that the client terminal may obtain the above meeting description information from the management calendar 2100. Alternatively, the client terminal may determine a meeting reminder message corresponding to the meeting event, and acquire corresponding meeting description information from the meeting reminder message.

In another embodiment, the task reminder message may not include the meeting description information. For example, in one case, the task reminder message may include identification information of the meeting, so that after receiving the task reminder message, the recipient client terminal may obtain at least one piece of corresponding meeting description information from the server terminal based on the identification information, or search for the corresponding meeting reminder message or meeting event to acquire the corresponding meeting description information in historical reminder messages of the recipient client terminal according to the identification information. In another case, the client terminal may inform the server terminal of association information between the task reminder message and the meeting, and the task reminder message may include a meeting association ID. The meeting association ID may indicate to the recipient client terminal that the task reminder message has an associated meeting, and the recipient client terminal may initiate an inquiry to the server terminal, so that the server terminal returns at least one piece of corresponding meeting description information to the recipient client terminal based on the above association information.

In this embodiment, when the reminded object does not participate in the meeting, the reminded object is equivalent to being independent of the participants of the meeting, so the reminded object may have a task management permission for the task reminder message to determine the task processing status of the reminded object.

In this embodiment, when the reminded object participates in the meeting and is configured as a task leader, the reminded object may have a task management permission for the task reminder message. When the reminded object participates in the meeting and is configured as a task participant, the reminded object may not have a task management permission for the task reminder message. In this case, the task leader and the task participant are equivalent to a whole, and the task leader implements a unified task management operation on behalf of the whole.

Similar to the embodiment shown in FIG. 20, FIG. 22 is a flowchart of still another sender-based task reminder method according to an exemplary embodiment of the present disclosure. As shown in FIG. 22, the method is applied to an electronic device of a sender, which may include the following steps.

In step 2202, a client terminal generates a task reminder message related to a meeting according to a reminded object, task description information, and the meeting.

In step 2204, the client terminal sends the task reminder message including the task description information to the reminded object.

The functional logic of this embodiment may be obtained with reference to the embodiment shown in FIG. 20, which is not repeated here.

It should be noted that in addition to being applicable to a client terminal run on an electronic device of a sender such as a mobile phone or a PC so that the client terminal implements functions such as generating and sending a task reminder message, in some cases, the embodiments shown in FIG. 20 and FIG. 22 are also applicable to a server terminal so that the server terminal implements the functions such as generating and sending a task reminder message by running the steps included in the embodiment. Even in some cases, the embodiments shown in FIG. 20 and FIG. 22 may be further applied to other possible execution bodies, and the execution bodies implement the functions such as generating and sending a task reminder message by running the steps included in the embodiment, which is not limited in the present disclosure.

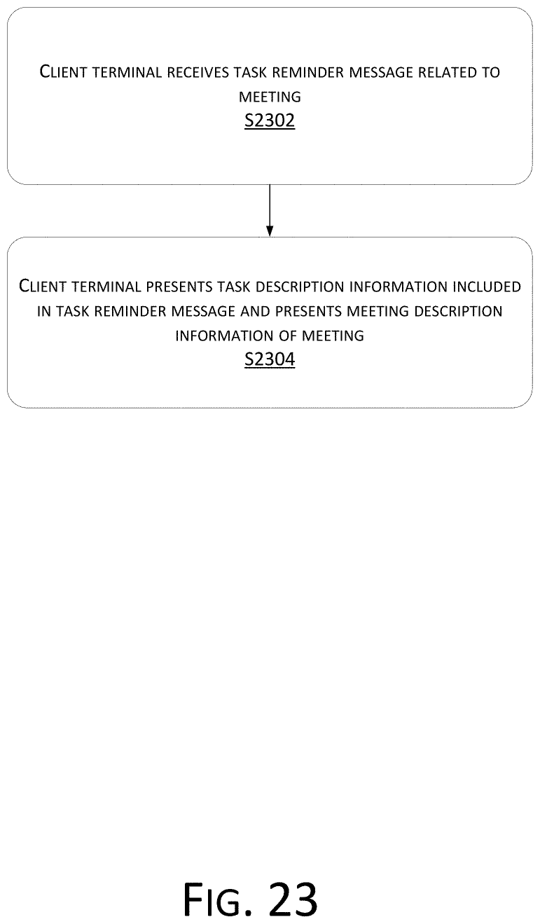

Corresponding to the embodiments shown in FIG. 20 or FIG. 22, FIG. 23 is a flowchart of still another recipient-based task reminder method according to an exemplary embodiment of the present disclosure. As shown in FIG. 23, the method is applied to an electronic device of a recipient, which may include the following steps.

In step 2302, a client terminal receives a task reminder message related to a meeting.

In step 2304, the client terminal presents task description information included in the task reminder message and presents meeting description information of the meeting.

In this embodiment, when the task reminder message includes meeting description information, the client terminal may acquire the meeting description information included in the task reminder message and present the meeting description information and task description information included in the task reminder message.

In this embodiment, the task reminder message may not include meeting description information. In an implementation mode, the task reminder message may include identification information of the meeting, and the client terminal may acquire corresponding meeting description information according to the identification information. For example, the client terminal may search historical reminder messages according to the identification information to search for the corresponding meeting event or meeting reminder message and acquire meeting description information included in the meeting event or meeting reminder message. For another example, the client terminal may initiate a query to the server terminal according to the identification information, so that the server terminal returns corresponding meeting description information to the client terminal. In another implementation mode, the task reminder message may include a meeting association ID, so that the client terminal determines that the task reminder message has an associated meeting, and then the client terminal may initiate a query related to the task reminder message to the server terminal. If a sender client terminal informs the server terminal of an association between the task reminder message and the meeting in advance, the server terminal may determine the meeting based on the association, and then the client terminal may receive meeting description information of the meeting returned by the server terminal.

In this embodiment, the client terminal may present at least a part of the content of the meeting description information in a presentation area of the task reminder message. The presentation area may include a detail presentation interface specific to the task reminder message, or a presentation area corresponding to the task reminder message in the above reminder message management page.

In this embodiment, the client terminal may present at least a part of the content of the task description information in a presentation area of the meeting reminder message corresponding to the meeting. The presentation area may include a detail presentation interface specific to the meeting reminder message, or a presentation area corresponding to the meeting reminder message in the above reminder message management page.

In this embodiment, the client terminal may display a first trigger option related to the meeting in a presentation area of the task reminder message, wherein the client terminal presents the meeting description information when the first trigger option is triggered. When the client terminal has known the meeting description information, the first trigger option may include summary information of the meeting description information, and the client terminal displays detail information of the meeting description information based on the trigger operation for the first trigger option. The detail information may be presented in the presentation area of the task reminder message or presented in a separate interface (such as a detail presentation interface specific to the meeting reminder message or a temporary window interface). When the client terminal has not known the meeting description information yet, the first trigger option may include an indicative option such as “click to know the associated meeting,” and the client terminal acquires the corresponding meeting description information for presentation based on the trigger operation for the first trigger option.

In this embodiment, the client terminal may display a second trigger option related to the task description information in a presentation area of the meeting reminder message, wherein the client terminal presents the task description information when the second trigger option is triggered. For example, the first trigger option may include summary information of the task description information, and the client terminal displays detail information of the task description information based on the trigger operation for the first trigger option. The detail information may be presented in the presentation area of the meeting reminder message or presented in a separate interface (such as a detail presentation interface specific to the task reminder message or a temporary window interface).

In this embodiment, the client terminal may perform task management on a task event corresponding to the task reminder message according to a trigger operation for the task event. For example, the task management may include pause, suspension and completion of the task event, which is not limited in the present disclosure. According to different permissions of logged-in users of the client terminal, the client terminal may implement different types of task management. The client terminal may not be able to implement task management when a logged-in user has no permission.

In the above embodiment, the technical solution of the present disclosure is described by taking an association between a task reminder message and a meeting reminder message as well as between the task reminder message and a meeting. It should be noted that in the technical solution of the present disclosure, the “task” may be interpreted differently under different circumstances. In some scenarios, for example, the “task” may be understood as a pending matter (for example, in the work scenario, it may be manifested as working content), and an undertaker (such as the reminded object in the present disclosure) of the “task” needs to complete the pending matter, and provide feedback (such as a notification of “complete task”) to a sender of the task reminder message. In other scenarios, the “task” may be interpreted as a notification or similar description information, and the undertaker of the “task” may need to deal with the matter or may only need to be informed of the notification. There may be other interpretations in other scenarios, which is not limited in the present disclosure. In addition, some simpler “tasks” may each include only one pending matter or notification, while some more complex “tasks” may each include more than one pending matters or notifications.

Certainly, in addition to the correlation between the task reminder message and the meeting reminder message or the meeting, in fact, the technical solution of the present disclosure may be further extended to the correlation between any type of reminder messages, which will be described below with reference to embodiments.

It should be noted that in addition to being applicable to a client terminal run on an electronic device of a recipient such as a mobile phone or a PC so that the client terminal implements functions such as receiving a task reminder message and presenting task description information and meeting description information, in some cases, the embodiment shown in FIG. 23 is also applicable to a server terminal so that the server terminal implements the functions such as receiving a task reminder message and presenting task description information and meeting description information to a recipient (such as sending task description information and meeting description information to a client terminal corresponding to the recipient) by running the steps included in the embodiment. Even in some cases, the embodiment shown in FIG. 23 may be further applied to other possible execution bodies, and the execution bodies implement the functions such as receiving a task reminder message and presenting task description information and meeting description information to a recipient by running the steps included in the embodiment, which is not limited in the present disclosure.

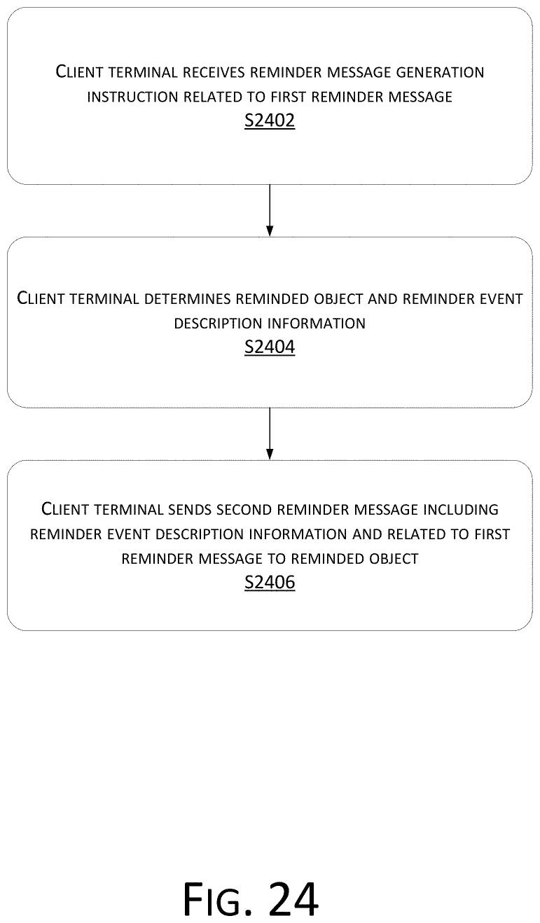

FIG. 24 is a flowchart of a method for generating a reminder message according to an exemplary embodiment of the present disclosure. As shown in FIG. 24, the method may include the following steps.

In step 2402, a client terminal receives a reminder message generation instruction related to a first reminder message.

In this embodiment, the client terminal may provide various types of reminder messages. For example, a meeting reminder message is used for implementing a reminding function for a meeting event, a task reminder message is used for implementing a reminding function for a task event, an urgent reminder message is used for implementing a reminding function for an examination and approval event, and so on. By setting corresponding types of the reminder messages, it is convenient for a user to classify different reminder messages for display and management, which is conducive to improving the reminding effect of the reminder messages and improving the event processing efficiency of the user.

In this embodiment, the first reminder message and the second reminder message may be reminder messages of the above any type respectively. The first reminder message and the second reminder message may be of the same type, for example, the first reminder message and the second reminder message may be of a task type, a meeting type, an urgent type or the like at the same time. The first reminder message and the second reminder message may be of different types, for example, when the first reminder message is of the meeting type and the second reminder message is of the task type, the embodiment shown in FIG. 24 is equivalent to the embodiment shown in FIG. 2. For another example, the first reminder message may be of the task type, and the second reminder message may be of the meeting type, or the first reminder message may be of the meeting type and the second reminder message may be of the urgent type, and so on.

In this embodiment, the client terminal may provide multiple ways of generating a second reminder message, so there are multiple ways of acquiring the above reminder message generation instruction related to the first reminder message, which is not limited in the present disclosure. For example,

In an implementation mode, the client terminal may display a second reminder message creation option in a presentation interface of the first reminder message; and then the client terminal may determine that the reminder message generation instruction is received when receiving a trigger operation for the second reminder message creation option. The presentation interface of the first reminder message includes any interface in which the first reminder message may be presented, for example, a detail presentation interface specific to the first reminder message, or a reminder message management page for centralized presentation of the first reminder message and other reminder messages, and so on. Certainly, in addition to displaying a second reminder message creation option and performing a trigger operation on the second reminder message creation option by the user, the client terminal may also provide other triggering forms for the first reminder message, for example, draw a preset touch gesture on the above presentation interface, send a control voice, and so on, which is not limited in the present disclosure. In addition, the “second reminder message creation option” is only an option form that may be adopted, and another task-related function option may also be applied here to replace the “second reminder message creation option.” For example, the function option may be a “second reminder message editing option” or “second reminder message modification option.” When the “second reminder message editing option” or “second reminder message modification option” is triggered, a second reminder message template related to the first reminder message may be displayed to enable the sender to edit or modify the template to obtain a second reminder message related to the first reminder message.

In another implementation mode, the client terminal may receive a user creation operation for the second reminder message and a first reminder message binding operation for the second reminder message; and then the client terminal may determine that the reminder message generation instruction related to the first reminder message is received when the first reminder message is selected by the first reminder message binding operation. For example, the client terminal may provide the user with a user creation operation for the second reminder message, and when the user triggers the creation option through the user creation operation, the client terminal may further provide the user with an alternative first reminder message (such as first reminder messages that have been received and sent by the client terminal) to allow the user to select, through a user selection operation, a first reminder message that the user wants to bind to the second reminder message.

In step 2404, the client terminal determines a reminded object and reminder event description information.

In this embodiment, the reminded object may include at least one of the following: an associated user of the first reminder message (for example, the associated user may be a meeting participant when the first reminder message is a meeting reminder message), and an object that is selected by an object selection operation received by the client terminal. In an implementation mode, the client terminal may present the associated user of the first reminder message and an associated user of the sender as alternative users to allow the sender to select a sender-wanted user to serve as the reminded object. In another implementation mode, the client terminal may take the associated user of the first reminder message as the reminded object by default and present the associated user of the sender as an alternative user for presentation to allow the sender to further add the sender-wanted user to serve as the reminded object. In one case, the associated user of the first reminder message may be set to be required as the reminded object, and in the other case, although the associated user of the first reminder message is added as the reminded object by default, the sender may make adjustment according to an actual situation.

In step 2406, the client terminal sends a second reminder message including the reminder event description information and related to the first reminder message to the reminded object.

In an embodiment, assuming that the second reminder message includes second reminder event description information, the second reminder message may further include first reminder event description information in the first reminder message, that is, the client terminal may add at least one piece of first reminder event description information in the first reminder message to the second reminder message to present it to the recipient.

In another embodiment, the second reminder message may not include first reminder event description information. For example, in one case, the second reminder message may include identification information of the first reminder message, so that after receiving the second reminder message, the recipient client terminal may obtain at least one piece of corresponding first reminder event description information from the server terminal according to the identification information, or search for the corresponding first reminder message and first reminder event description information thereof in historical reminder messages of the recipient client terminal according to the identification information. In another case, the client terminal may inform the server terminal of association information between the second reminder message and the first reminder message, and the second reminder message may include a meeting association ID. The meeting association ID may indicate to the recipient client terminal that the second reminder message has an associated first reminder message, and the recipient client terminal may initiate an inquiry to the server terminal, so that the server terminal returns at least one piece of first reminder event description information of the corresponding first reminder message to the recipient client terminal based on the above association information.

In this embodiment, when the reminded object is not an associated user of the first reminder message, the reminded object may have a management permission for a corresponding event of the second reminder message to determine a processing status of the reminded object for the corresponding event.

In this embodiment, when the reminded object belongs to an associated user of the first reminder message and is configured as an event lead of the corresponding event of the second reminder message, the reminded object may have a management permission for the corresponding event. When the reminded object belongs to an associated user of the first reminder message and is configured as an event participant of the corresponding event of the second reminder message, the reminded object may not have a management permission for the corresponding event. In this case, the event leader and the event participant are equivalent to a whole, and the event leader implements a unified event management operation on behalf of the whole.

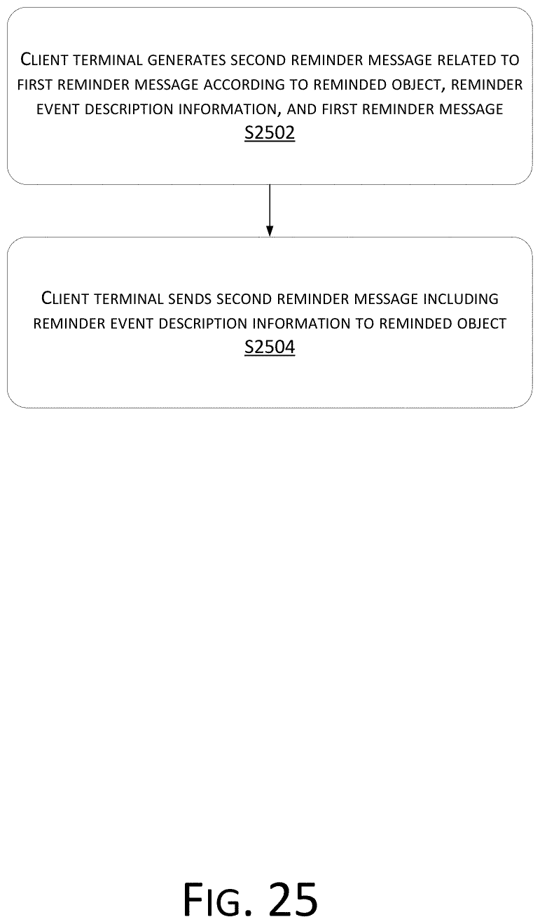

FIG. 25 is a flowchart of another method for generating a reminder message according to an exemplary embodiment of the present disclosure. As shown in FIG. 25, the method may include the following steps.

In step 2502, a client terminal generates a second reminder message related to a first reminder message according to a reminded object, reminder event description information, and the first reminder message.

In step 2504, the client terminal sends the second reminder message including the reminder event description information to the reminded object.

The functional logic of this embodiment may be obtained with reference to the embodiment shown in FIG. 24, which is not repeated here.

It should be noted that in addition to being applicable to a client terminal run on an electronic device of a sender such as a mobile phone or a PC so that the client terminal implements functions such as generating and sending a second reminder message, in some cases, the embodiments shown in FIG. 24 and FIG. 25 are also applicable to a server terminal so that the server terminal implements the functions such as generating and sending a second reminder message by running the steps included in the embodiment. Even in some cases, the embodiments shown in FIG. 24 and FIG. 25 may be further applied to other possible execution bodies, and the execution bodies implement the functions such as generating and sending a second reminder message by running the steps included in the embodiment, which is not limited in the present disclosure.

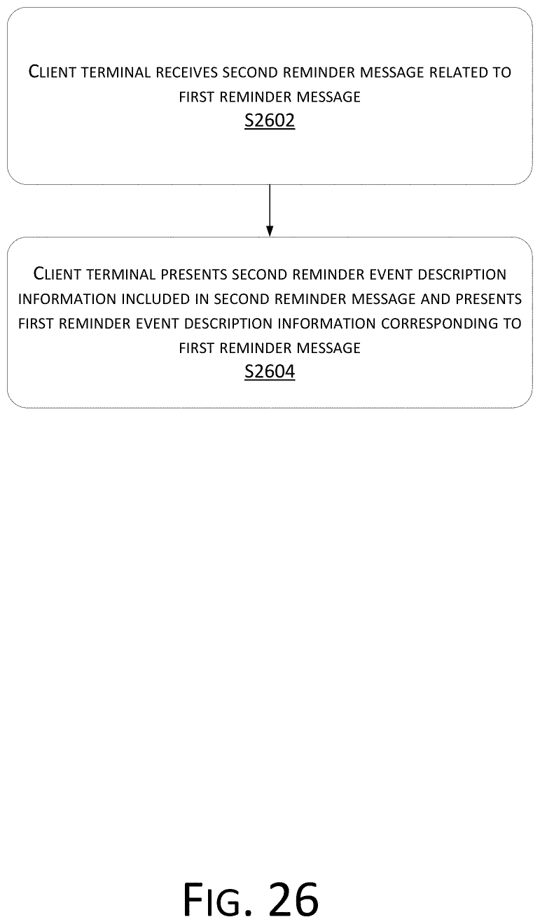

Corresponding to the embodiments shown in FIG. 24 or FIG. 25, FIG. 26 is a flowchart of a method for presenting a reminder message according to an exemplary embodiment of the present disclosure. As shown in FIG. 26, the method may include the following steps.

In step 2602, a client terminal receives a second reminder message related to a first reminder message.

In step 2604, the client terminal presents second reminder event description information included in the second reminder message and presents first reminder event description information corresponding to the first reminder message.

In this embodiment, when the second reminder message includes first reminder event description information, the client terminal may acquire the first reminder event description information included in the second reminder message and present the first reminder event description information and second reminder event description information included in the second reminder message.

In this embodiment, the second reminder message may not include first reminder event description information. In an implementation manner, the second reminder message may include identification information of the first reminder message, and the client terminal may acquire corresponding first reminder event description information according to the identification information. For example, the client terminal may search historical reminder messages according to the identification information to search for the corresponding first reminder message and acquire first reminder event description information included in the first reminder message. For another example, the client terminal may initiate a query to the server terminal according to the identification information, so that the server terminal returns a corresponding first reminder message or first reminder event description information to the client terminal. In another implementation mode, the second reminder message may include a meeting association ID, so that the client terminal determines that the second reminder message has an associated first reminder message, and then the client terminal may initiate a query related to the second reminder message to the server terminal. If a sender client terminal informs the server terminal of an association between the second reminder message and the first reminder message in advance, the server terminal may determine the first reminder message based on the association, and then the client terminal may receive the first reminder message or first reminder event description information returned by the server terminal.

In this embodiment, the client terminal may present at least a part of the first reminder event description information in a presentation area of the second reminder message. The presentation area may include a detail presentation interface specific to the second reminder message, or a presentation area corresponding to the second reminder message in the above reminder message management page.

In this embodiment, the client terminal may present at least a part of the second reminder event description information in a presentation area of the first reminder message. The presentation area may include a detail presentation interface specific to the first reminder message, or a presentation area corresponding to the first reminder message in the above reminder message management page.

In this embodiment, the client terminal may display a first trigger option related to the first reminder message in a presentation area of the second reminder message, wherein the client terminal presents the first reminder event description information in the first reminder message when the first trigger option is triggered. When the client terminal has known the first reminder event description information, the first trigger option may include summary information of the first reminder event description information, and the client terminal may display detail information of the first reminder event description information based on the trigger operation for the first trigger option. The detail information may be presented in the presentation area of the second reminder message or presented in a separate interface (such as a detail presentation interface specific to the first reminder message or a temporary window interface). When the client terminal has not known the first reminder event description information yet, the first trigger option may include an indicative option such as “click to know the associated event,” and the client terminal may acquire the corresponding first reminder event description information for presentation based on the trigger operation for the first trigger option.

In this embodiment, the client terminal may display a second trigger option related to the second reminder event description information in a presentation area of the first reminder message, wherein the client terminal presents the second reminder event description information when the second trigger option is triggered. For example, the first trigger option may include summary information of the second reminder event description information, and the client terminal may display detail information of the second reminder event description information based on the trigger operation for the first trigger option. The detail information may be presented in the presentation area of the first reminder message or presented in a separate interface (such as a detail presentation interface specific to the second reminder message or a temporary window interface).

In this embodiment, the client terminal may perform event management on a corresponding event of the second reminder message according to a trigger operation for the corresponding event. For example, the event management may include pause, suspension and completion of the corresponding event, which is not limited in the present disclosure. According to different permissions of logged-in users of the client terminal, the client terminal may implement different types of event management. The client terminal may not be able to implement event management when a logged-in user has no permission.

It should be noted that in addition to being applicable to a client terminal run on an electronic device of a recipient such as a mobile phone or a PC so that the client terminal implements functions such as receiving a second reminder message and presenting second reminder event description information and first reminder event description information, in some cases, the embodiment shown in FIG. 26 is also applicable to a server terminal so that the server terminal implements the functions such as receiving a second reminder message and presenting second reminder event description information and first reminder event description information to a recipient (such as sending second reminder event description information and first reminder event description information to a client terminal corresponding to the recipient) by running the steps included in the embodiment. Even in some cases, the embodiment shown in FIG. 26 may be further applied to other possible execution bodies, and the execution bodies implement the functions such as receiving a second reminder message and presenting second reminder event description information and first reminder event description information to a recipient by running the steps included in the embodiment, which is not limited in the present disclosure.

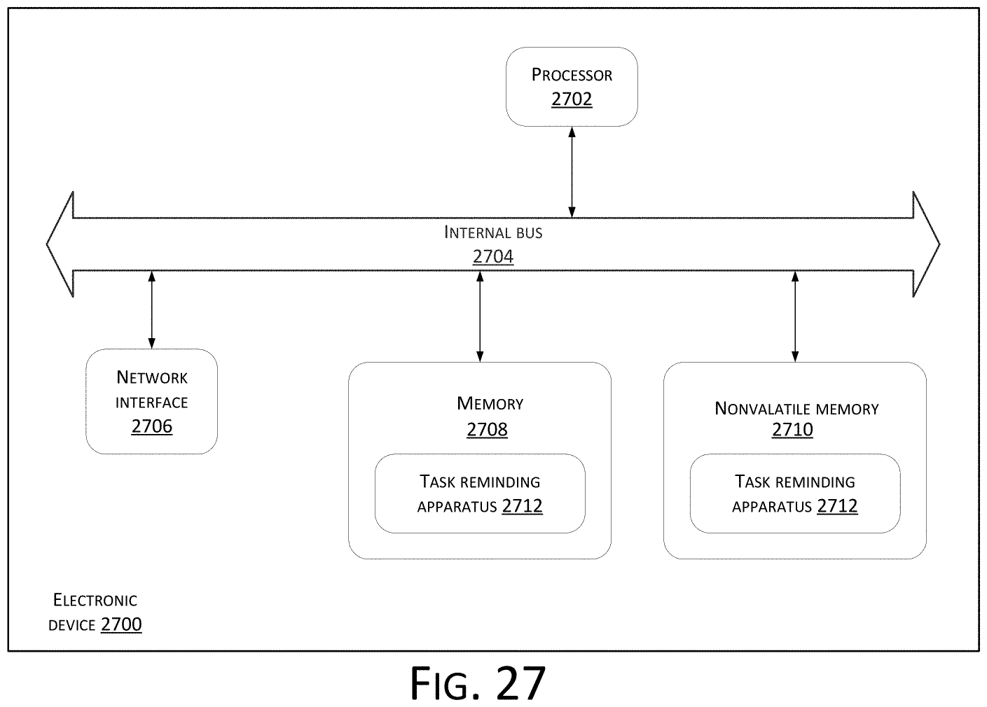

FIG. 27 is a schematic structural diagram of an electronic device 2700 according to an exemplary embodiment of the present disclosure. Referring to FIG. 27, at the hardware level, the electronic device 2700 includes a processor 2702, an internal bus 2704, a network interface 2706, a memory 2708, and a non-volatile memory 2710, and may further include hardware required by other services. The processor 2702 reads a corresponding computer program from the non-volatile memory 2710 to the memory 2708 for running, which forms a task reminder apparatus 2712 at the logical level. Certainly, in addition to the software implementation manner, the present disclosure does not exclude other implementation manners, such as logic devices or a combination of software and hardware, etc. In other words, the following processing procedure may not be performed only by various logic units, but also may be performed by hardware or logic devices. Both the memory 2708 and the non-volatile memory 2710 are examples of computer readable media.

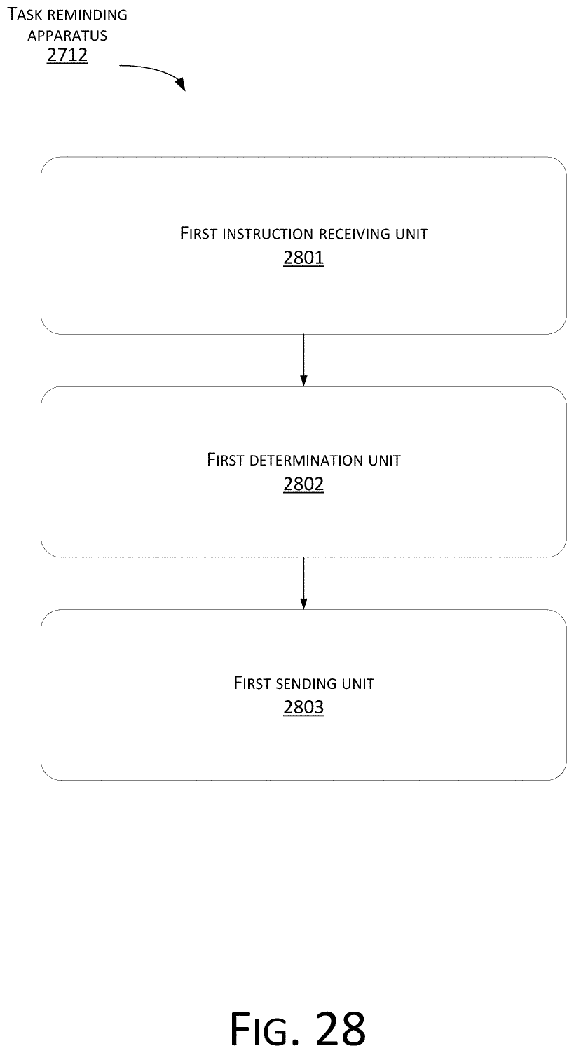

Referring to FIG. 28, in a software implementation mode, the task reminder apparatus 2712 may include:
a first instruction receiving unit 2801 configured to cause a client terminal to receive a task reminder message generation instruction related to a meeting reminder message;
a first determination unit 2802 configured to cause the client terminal to determine a reminded object and task description information;
and a first sending unit 2803 configured to cause the client terminal to send a task reminder message including the task description information and related to the meeting reminder message to the reminded object.

For example, the first instruction receiving unit 2801 is specifically configured to:
cause the client terminal to display a task creation option in a presentation interface of the meeting reminder message; and
cause the client terminal to determine that the task reminder message generation instruction is received when a trigger operation for the task creation option is received.

For example, the first instruction receiving unit 2801 is specifically configured to:
cause the client terminal to receive a user creation operation for the task reminder message and a meeting binding operation for the task reminder message; and
cause the client terminal to determine that the task reminder message generation instruction related to the meeting reminder message is received when the meeting reminder message is selected by the meeting binding operation.

For example, the task reminder message further includes meeting description information in the meeting reminder message.

For example, the reminded object includes at least one of the following:
a participant of a meeting corresponding to the meeting reminder message, and an object that is selected by an object selection operation received by the client terminal.

For example, the reminded object has a task management permission for the task reminder message when the reminded object does not participate in a meeting corresponding to the meeting reminder message; and
the reminded object has a task management permission for the task reminder message when the reminded object participates in the meeting and is configured as a task leader.

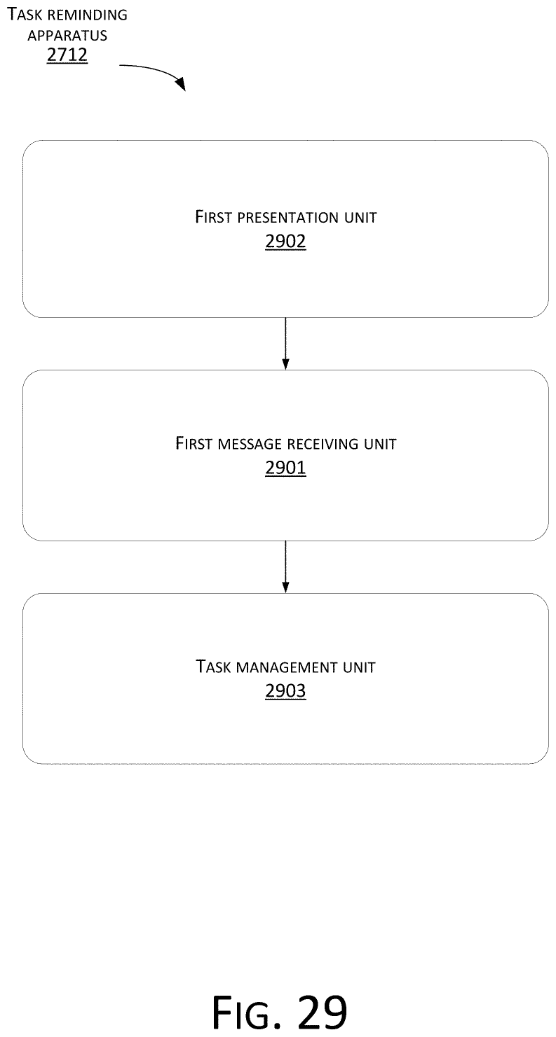

Referring to FIG. 29, in a software implementation mode, the task reminder apparatus 2712 may include:
a first message receiving unit 2901 configured to cause a client terminal to receive a task reminder message related to a meeting reminder message; and
a first presentation unit 2902 configured to cause the client terminal to present task description information included in the task reminder message and meeting description information in the meeting reminder message.

For example, the first presentation unit 2902 causes the client terminal to present task description information included in the task reminder message and meeting description information in the meeting reminder message in at least one of the following manners:
causing the client terminal to present at least a part of the content of the meeting description information in a presentation area of the task reminder message; and
causing the client terminal to present at least a part of the content of the task description information in a presentation area of the meeting reminder message.

For example, the first presentation unit 2902 causes the client terminal to present task description information included in the task reminder message and meeting description information in the meeting reminder message in at least one of the following manners:
causing the client terminal to display a first trigger option related to the meeting reminder message in a presentation area of the task reminder message, wherein the client terminal presents the meeting description information in the meeting reminder message when the first trigger option is triggered; and
causing the client terminal to display a second trigger option related to the task description information in a presentation area of the meeting reminder message, wherein the client terminal presents the task description information when the second trigger option is triggered.

For example, the task reminder apparatus further includes:
a task management unit 2903 configured to cause the client terminal to perform task management on a task event corresponding to the task reminder message according to a trigger operation for the task event.

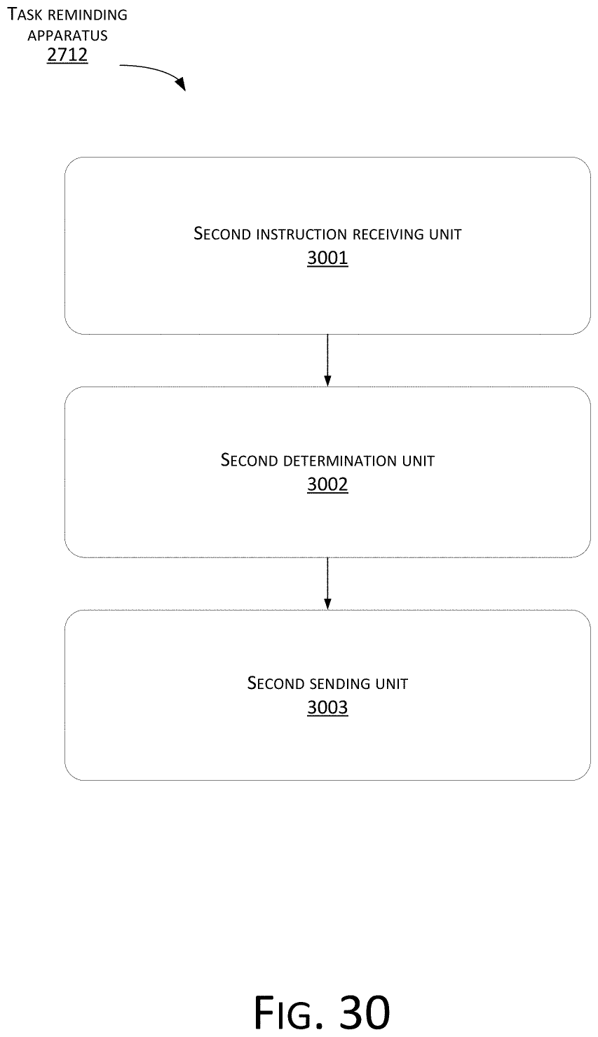

Referring to FIG. 30, in a software implementation mode, the task reminder apparatus 2712 may include:
a second instruction receiving unit 3001 configured to cause a client terminal to receive a task reminder message generation instruction related to a meeting reminder message;
a second determination unit 3002 configured to cause the client terminal to determine a reminded object and task description information; and
a second sending unit 3003 configured to cause the client terminal to send a task reminder message related to a meeting corresponding to the meeting reminder message to a reminded object that participates in the meeting and a task reminder message unrelated to the meeting to a reminded object that does not participate in the meeting, the task reminder message including the task description information.

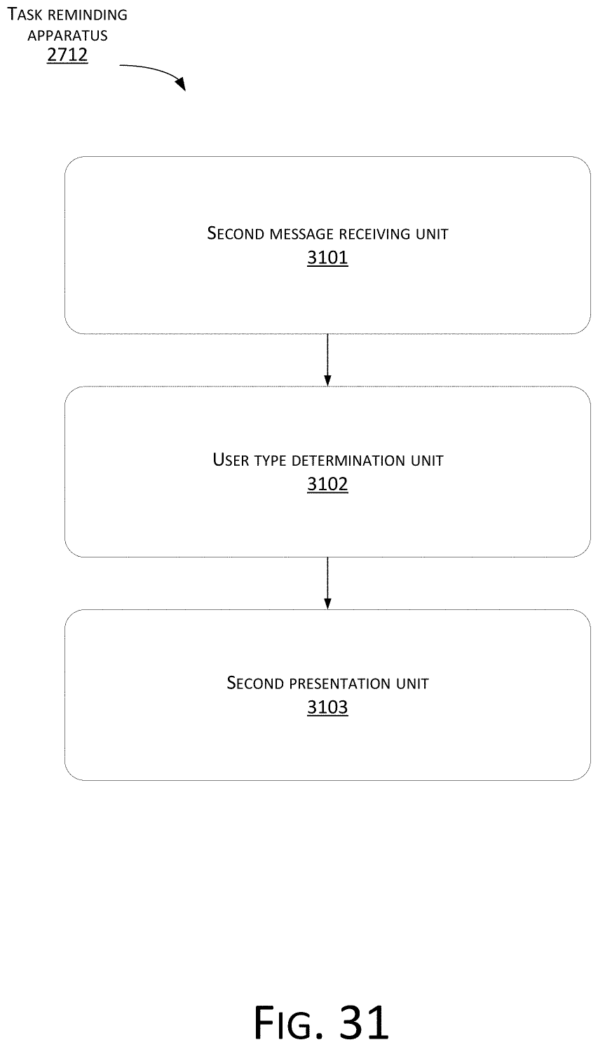

Referring to FIG. 31, in a software implementation mode, the task reminder apparatus 2712 may include:
a second message receiving unit 3101 configured to cause a client terminal to receive a task reminder message related to a meeting reminder message;
a user type determination unit 3102 configured to cause the client terminal to determine whether a logged user participates in a meeting corresponding to the meeting reminder message; and
a second presentation unit 3103 configured to cause the client terminal to present task description information included in the task reminder message and present meeting description information of the meeting when the logged user participates in the meeting; and cause the client terminal to present the task description information included in the task reminder message when the logged user does not participate in the meeting.

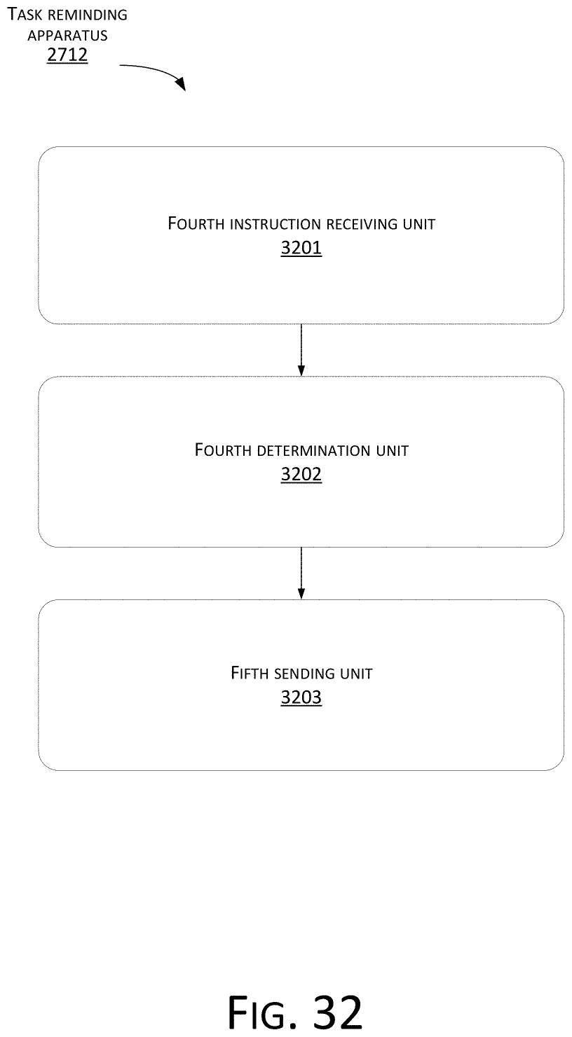

Referring to FIG. 32, in a software implementation mode, the task reminder apparatus 2712 may include:
a fourth instruction receiving unit 3201 configured to cause a client terminal to receive a task reminder message generation instruction related to a meeting;
a fourth determination unit 3202 configured to cause the client terminal to determine a reminded object and task description information; and
a fifth sending unit 3203 configured to cause the client terminal to send a task reminder message including the task description information and related to the meeting to the reminded object.

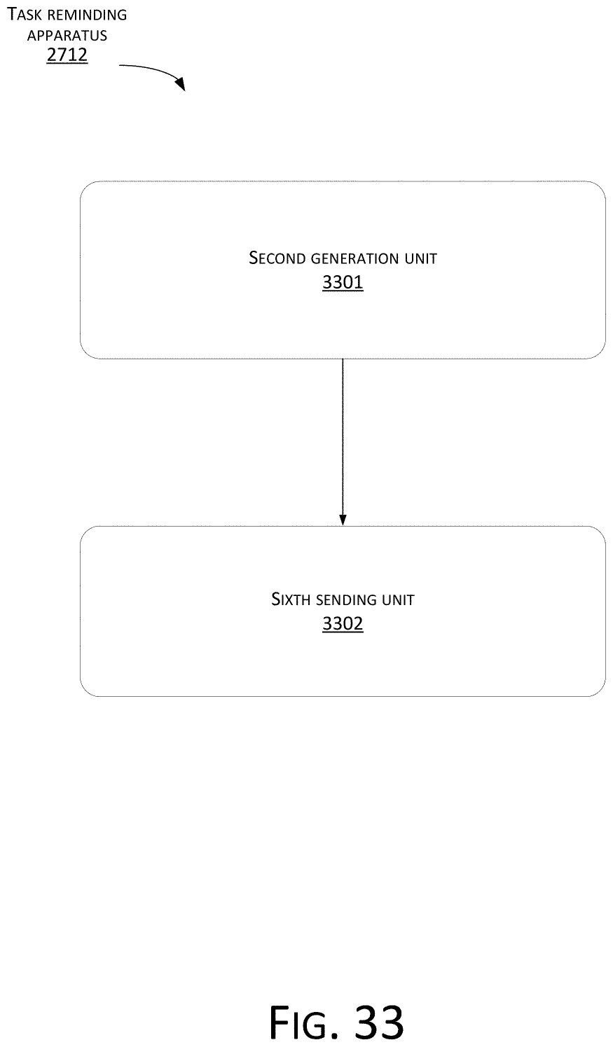

Referring to FIG. 33, in a software implementation mode, the task reminder apparatus 2712 may include:
a second generation unit 3301 configured to cause a client terminal to generate a task reminder message related to a meeting according to a reminded object, task description information, and the meeting; and
a sixth sending unit 3302 configured to cause the client terminal to send the task reminder message including the task description information to the reminded object.

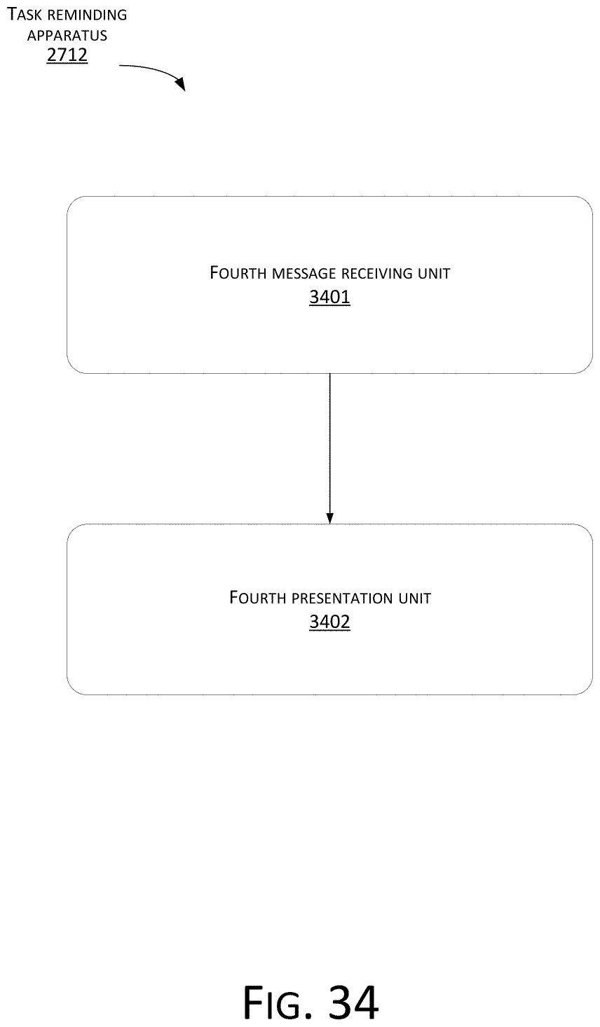

Referring to FIG. 34, in a software implementation mode, the task reminder apparatus 2712 may include:
a fourth message receiving unit 3401 configured to cause a client terminal to receive a task reminder message related to a meeting; and
a fourth presentation unit 3402 configured to cause the client terminal to present task description information included in the task reminder message and present meeting description information of the meeting.

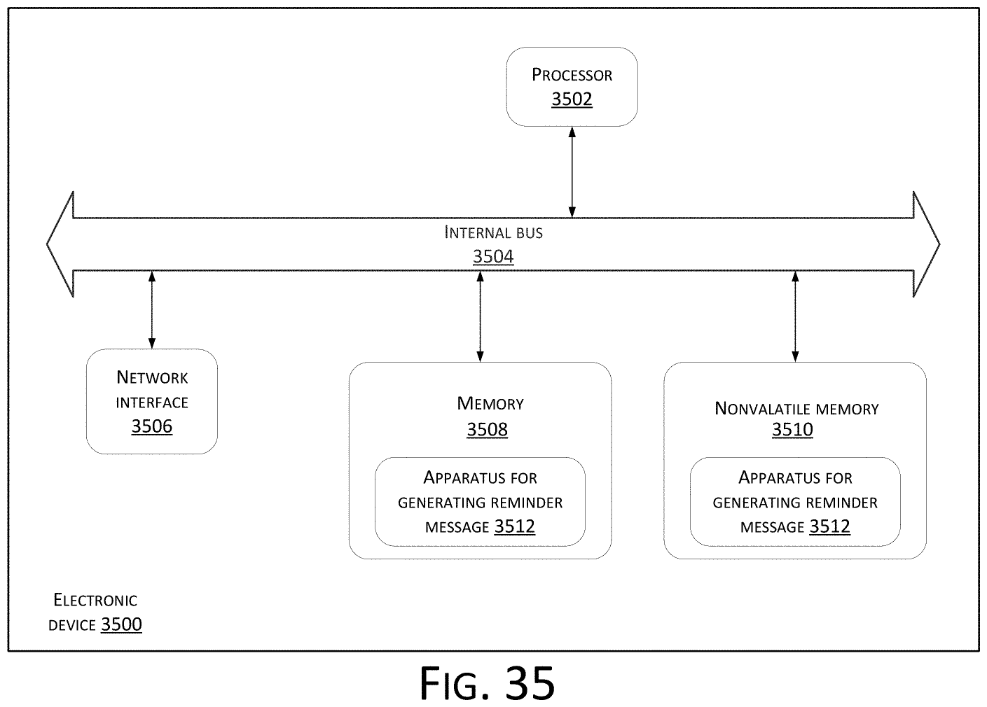

FIG. 35 is a schematic structural diagram of another electronic device 3500 according to an exemplary embodiment of the present disclosure. Referring to FIG. 35, at the hardware level, the electronic device 3500 includes a processor 3502, an internal bus 3504, a network interface 3506, a memory 3508, and a non-volatile memory 3510, and definitely may further include hardware required by other services. The processor 3502 reads a corresponding computer program from the non-volatile memory 3510 to the memory 3508 for running, which forms an apparatus for generating a reminder message 3512 at the logical level. Certainly, in addition to the software implementation manner, the present disclosure does not exclude other implementation manners, such as logic devices or a combination of software and hardware, etc. In other words, the following processing procedure may not be performed only by various logic units, but also may be performed by hardware or logic devices. Both the memory 3508 and the non-volatile memory 3510 are examples of computer readable media.

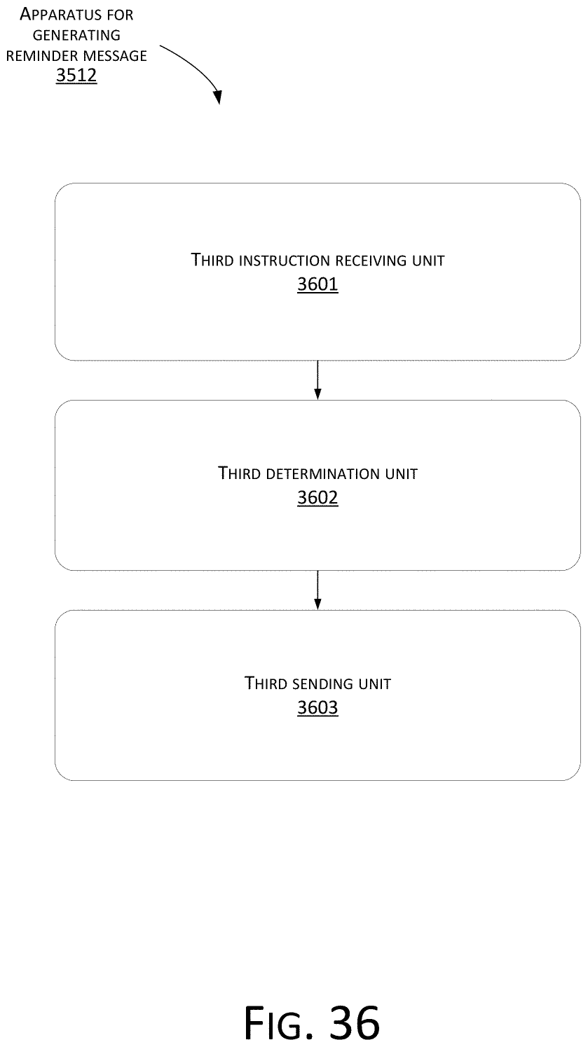

Referring to FIG. 36, in a software implementation mode, the apparatus for generating a reminder message 3512 may include:
a third instruction receiving unit 3601 configured to cause a client terminal to receive a reminder message generation instruction related to a first reminder message;
a third determination unit 3602 configured to cause the client terminal to determine a reminded object and reminder event description information; and
a third sending unit 3603 configured to cause the client terminal to send a second reminder message including the reminder event description information and related to the first reminder message to the reminded object.

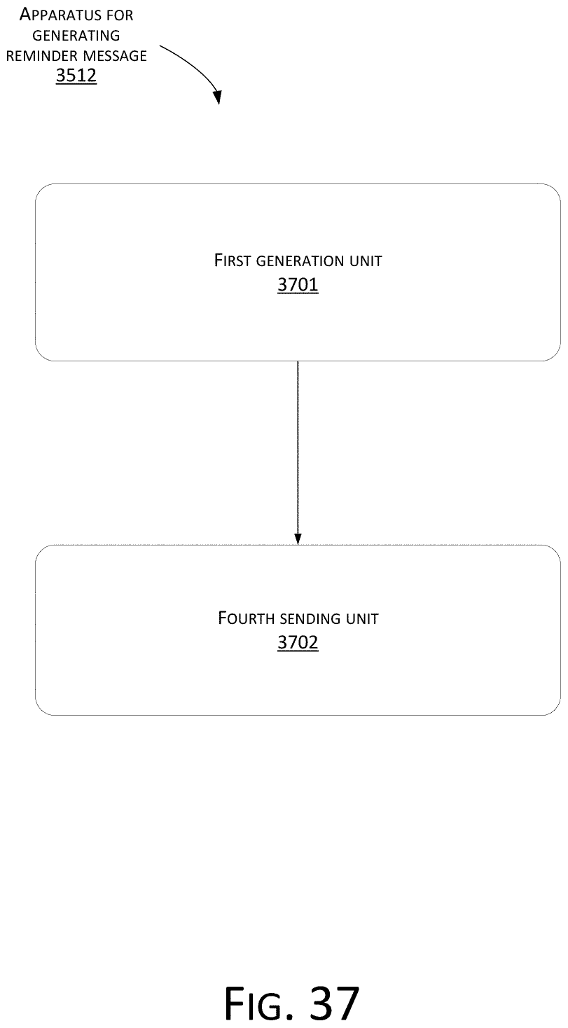

Referring to FIG. 37, in a software implementation mode, the apparatus for generating a reminder message 3512 may include:
a first generation unit 3701 configured to cause a client terminal to generate a second reminder message related to a first reminder message according to a reminded object, reminder event description information, and the first reminder message; and
a fourth sending unit 3702 configured to cause the client terminal to send the second reminder message including the reminder event description information to the reminded object.

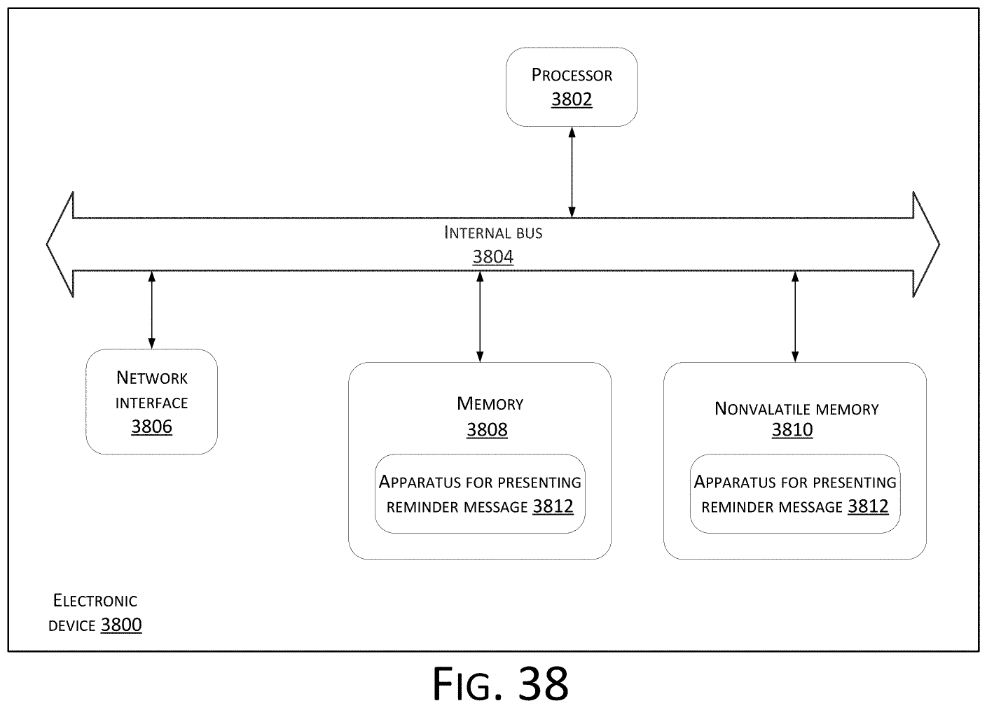

FIG. 38 is a schematic structural diagram of still another electronic device 3800 according to an exemplary embodiment of the present disclosure. Referring to FIG. 38, at the hardware level, the electronic device includes a processor 3802, an internal bus 3804, a network interface 3806, a memory 3808, and a non-volatile memory 3810, and definitely may further include hardware required by other services. The processor 3802 reads a corresponding computer program from the non-volatile memory 3810 to the memory 3808 for running, which forms an apparatus for presenting a reminder message 3812 at the logical level. Certainly, in addition to the software implementation manner, the present disclosure does not exclude other implementation manners, such as logic devices or a combination of software and hardware, etc. In other words, the following processing procedure may not be performed only by various logic units, but also may be performed by hardware or logic devices. Both the memory 3808 and the non-volatile memory 3810 are examples of computer readable media.

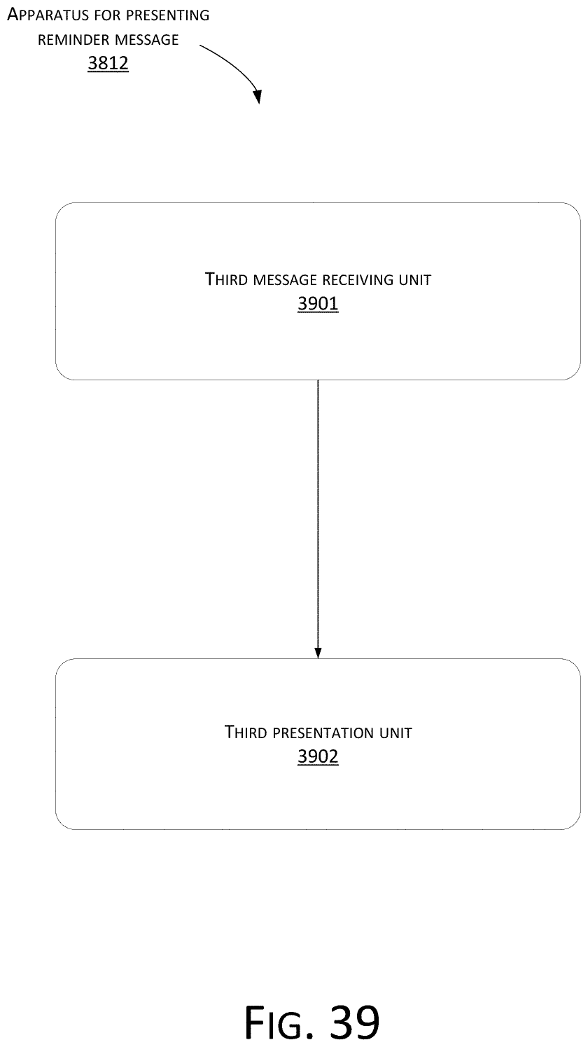

Referring to FIG. 39, in a software implementation mode, the apparatus for presenting a reminder message 3812 may include:
a third message receiving unit 3901 configured to cause a client terminal to receive a second reminder message related to a first reminder message; and
a third presentation unit 3902 configured to cause the client terminal to present second reminder event description information included in the second reminder message and present first reminder event description information corresponding to the first reminder message.

For example, the third presentation unit 3902 is specifically configured to:
cause the client terminal to present the first reminder event description information and the second reminder event description information associatively in a presentation area of the first reminder message or the second reminder message.

The system, apparatus, module or unit illustrated in the above embodiments may be implemented specifically by a computer chip or an entity, or by a product having a certain function. A typical implementation device is a computer. For example, the computer may be specifically in the form of a personal computer, a laptop computer, a cellular phone, a camera phone, a smart phone, a personal digital assistant, a media player, a navigation device, an email sending and receiving device, a game console, a tablet computer, a wearable device, or a combination of any of these devices.

In a typical configuration, the computer includes one or more central processing units (CPUs), an input/output interface, a network interface, and a memory.

The memory may include computer readable media such as a volatile memory, a Random Access Memory (RAM), and/or non-volatile memory, e.g., a Read-Only Memory (ROM) or a flash RAM. The memory is an example of a computer readable medium.

The computer readable medium includes non-volatile and volatile media as well as movable and non-movable media, and may implement information storage by means of any method or technology. The information may be a computer readable instruction, a data structure, and a module of a program or other data. An example of the storage medium of a computer includes, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

It should be further noted that the terms “include,” “comprise” or other variations thereof are intended to cover non-exclusive inclusion, so that a process, method, commodity or device including a series of elements not only includes the elements, but also includes other elements not clearly listed, or further includes elements inherent to the process, method, commodity or device. In the absence of more limitations, an element defined by “including a/an . . . ” does not exclude that the process, method, commodity or device including the element further has other identical elements.

Exemplary embodiments will be described in detail herein, and examples thereof are shown in the accompanying drawings. In the following description involving the accompanying drawings, the same numerals in different accompanying drawings denote the same or similar elements, unless specified otherwise. Implementations described in the following exemplary embodiments do not represent all implementations consistent with the present disclosure. In contrast, they are merely examples of apparatuses and methods consistent with some example embodiments of the present disclosure as described in detail in the appended claims.

Terms used in the present disclosure are merely used for describing specific embodiments, instead of limiting the present disclosure. Singular forms “a(n),” “said,” and “the” used in the present disclosure and the appended claims also include plural forms, unless clearly specified in the context that other meanings are denoted. It should be further understood that the term “and/or” used herein refers to and includes any or all possible combinations of one or more associated items listed.

It should be understood that, although terms such as “first,” “second,” and “third” may be used to describe various kinds of information in the present disclosure, these kinds of information should not be limited to the terms. These terms are merely used to distinguish information of the same type from each other. For example, without departing from the scope of the present disclosure, the first information may also be referred to as second information, and similarly, the second information may also be referred to as first information. Depending on the context, the word “if” used herein may be explained as “when . . . ,” “as . . . ,” or “in response to the determination.”

The above description is merely example embodiments of the present disclosure, and is not used to limit the present disclosure. Any modification, equivalent replacement, improvement and the like made within the spirit and principle of the present disclosure should be included in the protection scope of the present disclosure.

The present disclosure may further be understood with clauses as follows.

Clause 1. A task reminder method, comprising:
receiving, by a client terminal, a task reminder message generation instruction related to a meeting reminder message;
determining, by the client terminal, a reminded object and task description information; and
sending, by the client terminal, a task reminder message comprising the task description information and related to the meeting reminder message to the reminded object.

Clause 2. The method of clause 1, wherein the receiving, by a client terminal, a task reminder message generation instruction related to a meeting reminder message comprises:
displaying, by the client terminal, a task creation option in a presentation interface of the meeting reminder message; and
determining, by the client terminal, that the task reminder message generation instruction is received when receiving a trigger operation for the task creation option.

Clause 3. The method of clause 1, wherein the receiving, by a client terminal, a task reminder message generation instruction related to a meeting reminder message comprises:
receiving, by the client terminal, a user creation operation for the task reminder message and a meeting binding operation for the task reminder message; and
determining, by the client terminal, that the task reminder message generation instruction related to the meeting reminder message is received when the meeting reminder message is selected by the meeting binding operation.

Clause 4. The method of clause 1, wherein the task reminder message further comprises meeting description information in the meeting reminder message.

Clause 5. The method of clause 1, wherein the reminded object comprises at least one of the following:
a participant of a meeting corresponding to the meeting reminder message, and an object that is selected by an object selection operation received by the client terminal.

Clause 6. The method of clause 1, wherein
the reminded object has a task management permission for the task reminder message when the reminded object does not participate in a meeting corresponding to the meeting reminder message; and
the reminded object has a task management permission for the task reminder message when the reminded object participates in the meeting and is configured as a task leader.

Clause 7. A task reminder method, comprising:
receiving, by a client terminal, a task reminder message related to a meeting reminder message; and
presenting, by the client terminal, task description information comprised in the task reminder message and meeting description information in the meeting reminder message.

Clause 8. The method of clause 7, wherein the presenting, by the client terminal, task description information comprised in the task reminder message and meeting description information in the meeting reminder message comprises at least one of the following:
presenting, by the client terminal, at least a part of the content of the meeting description information in a presentation area of the task reminder message; and
presenting, by the client terminal, at least a part of the content of the task description information in a presentation area of the meeting reminder message.

Clause 9. The method of clause 7, wherein the presenting, by the client terminal, task description information comprised in the task reminder message and meeting description information in the meeting reminder message comprises at least one of the following:
displaying, by the client terminal, a first trigger option related to the meeting reminder message in a presentation area of the task reminder message, wherein the client terminal presents the meeting description information in the meeting reminder message when the first trigger option is triggered; and
displaying, by the client terminal, a second trigger option related to the task description information in a presentation area of the meeting reminder message, wherein the client terminal presents the task description information when the second trigger option is triggered.

Clause 10. The method of clause 7, further comprising:
performing, by the client terminal, task management on a task event corresponding to the task reminder message according to a trigger operation for the task event.

Clause 11. A task reminder method, comprising:
receiving, by a client terminal, a task reminder message generation instruction related to a meeting reminder message;
determining, by the client terminal, a reminded object and task description information; and
sending, by the client terminal, a task reminder message related to a meeting corresponding to the meeting reminder message to a reminded object that participates in the meeting and a task reminder message unrelated to the meeting to a reminded object that does not participate in the meeting, the task reminder message comprising the task description information.

Clause 12. A task reminder method, comprising:
receiving, by a client terminal, a task reminder message related to a meeting reminder message;
determining, by the client terminal, whether a logged-in user participates in a meeting corresponding to the meeting reminder message; and
presenting, by the client terminal, task description information comprised in the task reminder message and meeting description information of the meeting when the logged-in user participates in the meeting; and presenting, by the client terminal, the task description information comprised in the task reminder message when the logged-in user does not participate in the meeting.

Clause 13. A method for generating a reminder message, comprising:
receiving, by a client terminal, a reminder message generation instruction related to a first reminder message;
determining, by the client terminal, a reminded object and reminder event description information; and
sending, by the client terminal, a second reminder message comprising the reminder event description information and related to the first reminder message to the reminded object.

Clause 14. A method for generating a reminder message, comprising:
generating, by a client terminal, a second reminder message related to a first reminder message according to a reminded object, reminder event description information, and the first reminder message; and
sending, by the client terminal, the second reminder message comprising the reminder event description information to the reminded object.

Clause 15. A method for presenting a reminder message, comprising:
receiving, by a client terminal, a second reminder message related to a first reminder message; and
presenting, by the client terminal, second reminder event description information comprised in the second reminder message and first reminder event description information corresponding to the first reminder message.

Clause 16. The method of clause 15, wherein the presenting, by the client terminal, second reminder event description information comprised in the second reminder message and first reminder event description information comprised in the first reminder message comprises:
presenting, by the client terminal, the first reminder event description information and the second reminder event description information associatively in a presentation area of the first reminder message or the second reminder message.

Clause 17. A task reminder method, comprising:
receiving, by a client terminal, a task reminder message generation instruction related to a meeting;
determining, by the client terminal, a reminded object and task description information; and
sending, by the client terminal, a task reminder message comprising the task description information and related to the meeting to the reminded object.

Clause 18. A task reminder method, comprising:
generating, by a client terminal, a task reminder message related to a meeting according to a reminded object, task description information, and the meeting; and
sending, by the client terminal, the task reminder message comprising the task description information to the reminded object.

Clause 19. A task reminder method, comprising:
receiving, by a client terminal, a task reminder message related to a meeting; and
presenting, by the client terminal, task description information comprised in the task reminder message and meeting description information of the meeting.

Clause 20. A task reminder apparatus, comprising:
a first instruction receiving unit configured to cause a client terminal to receive a task reminder message generation instruction related to a meeting reminder message;
a first determination unit configured to cause the client terminal to determine a reminded object and task description information; and
a first sending unit configured to cause the client terminal to send a task reminder message comprising the task description information and related to the meeting reminder message to the reminded object.

Clause 21. The apparatus of clause 20, wherein the first instruction receiving unit is specifically configured to:
cause the client terminal to display a task creation option in a presentation interface of the meeting reminder message; and
cause the client terminal to determine that the task reminder message generation instruction is received when a trigger operation for the task creation option is received.

Clause 22. The apparatus of clause 20, wherein the first instruction receiving unit is specifically configured to:
cause the client terminal to receive a user creation operation for the task reminder message and a meeting binding operation for the task reminder message; and
cause the client terminal to determine that the task reminder message generation instruction related to the meeting reminder message is received when the meeting reminder message is selected by the meeting binding operation.

Clause 23. The apparatus of clause 20, wherein the task reminder message further comprises meeting description information in the meeting reminder message.

Clause 24. The apparatus of clause 20, wherein the reminded object comprises at least one of the following:
a participant of a meeting corresponding to the meeting reminder message, and an object that is selected by an object selection operation received by the client terminal.

Clause 25. The apparatus of clause 20, wherein
the reminded object has a task management permission for the task reminder message when the reminded object does not participate in a meeting corresponding to the meeting reminder message; and
the reminded object has a task management permission for the task reminder message when the reminded object participates in the meeting and is configured as a task leader.

Clause 26. A task reminder apparatus, comprising:
a first message receiving unit configured to cause a client terminal to receive a task reminder message related to a meeting reminder message; and
a first presentation unit configured to cause the client terminal to present task description information comprised in the task reminder message and meeting description information in the meeting reminder message.

Clause 27. The apparatus of clause 26, wherein the first presentation unit causes the client terminal to present task description information comprised in the task reminder message and meeting description information in the meeting reminder message in at least one of the following manners:
causing the client terminal to present at least a part of the content of the meeting description information in a presentation area of the task reminder message; and
causing the client terminal to present at least a part of the content of the task description information in a presentation area of the meeting reminder message.

Clause 28. The apparatus of clause 26, wherein the first presentation unit causes the client terminal to present task description information comprised in the task reminder message and meeting description information in the meeting reminder message in at least one of the following manners:
causing the client terminal to display a first trigger option related to the meeting reminder message in a presentation area of the task reminder message, wherein the client terminal presents the meeting description information in the meeting reminder message when the first trigger option is triggered; and
causing the client terminal to display a second trigger option related to the task description information in a presentation area of the meeting reminder message, wherein the client terminal presents the task description information when the second trigger option is triggered.

Clause 29. The apparatus of clause 26, further comprising:
a task management unit configured to cause the client terminal to perform task management on a task event corresponding to the task reminder message according to a trigger operation for the task event.

Clause 30. A task reminder apparatus, comprising:
a second instruction receiving unit configured to cause a client terminal to receive a task reminder message generation instruction related to a meeting reminder message;
a second determination unit configured to cause the client terminal to determine a reminded object and task description information; and
a second sending unit configured to cause the client terminal to send a task reminder message related to a meeting corresponding to the meeting reminder message to a reminded object that participates in the meeting and a task reminder message unrelated to the meeting to a reminded object that does not participate in the meeting, the task reminder message comprising the task description information.

Clause 31. A task reminder apparatus, comprising:
a second message receiving unit configured to cause a client terminal to receive a task reminder message related to a meeting reminder message;
a user type determination unit configured to cause the client terminal to determine whether a logged-in user participates in a meeting corresponding to the meeting reminder message; and
a second presentation unit configured to cause the client terminal to present task description information comprised in the task reminder message and present meeting description information of the meeting when the logged-in user participates in the meeting; and cause the client terminal to present the task description information comprised in the task reminder message when the logged-in user does not participate in the meeting.

Clause 32. An apparatus for generating a reminder message, comprising:
a third instruction receiving unit configured to cause a client terminal to receive a reminder message generation instruction related to a first reminder message;
a third determination unit configured to cause the client terminal to determine a reminded object and reminder event description information; and
a third sending unit configured to cause the client terminal to send a second reminder message comprising the reminder event description information and related to the first reminder message to the reminded object.

Clause 33. An apparatus for generating a reminder message, comprising:
a first generation unit configured to cause a client terminal to generate a second reminder message related to a first reminder message according to a reminded object, reminder event description information, and the first reminder message; and
a fourth sending unit configured to cause the client terminal to send the second reminder message comprising the reminder event description information to the reminded object.

Clause 34. An apparatus for presenting a reminder message, comprising:
a third message receiving unit configured to cause a client terminal to receive a second reminder message related to a first reminder message; and
a third presentation unit configured to cause the client terminal to present second reminder event description information comprised in the second reminder message and present first reminder event description information corresponding to the first reminder message.

Clause 35. The apparatus of clause 34, wherein the third presentation unit is specifically configured to:
cause the client terminal to present the first reminder event description information and the second reminder event description information associatively in a presentation area of the first reminder message or the second reminder message.

Clause 36. A task reminder apparatus, comprising:
a fourth instruction receiving unit configured to cause a client terminal to receive a task reminder message generation instruction related to a meeting;
a fourth determination unit configured to cause the client terminal to determine a reminded object and task description information; and
a fifth sending unit configured to cause the client terminal to send a task reminder message comprising the task description information and related to the meeting to the reminded object.

Clause 37. A task reminder apparatus, comprising:
a second generation unit configured to cause a client terminal to generate a task reminder message related to a meeting according to a reminded object, task description information, and the meeting; and
a sixth sending unit configured to cause the client terminal to send the task reminder message comprising the task description information to the reminded object.

Clause 38. A task reminder apparatus, comprising:
a fourth message receiving unit configured to cause a client terminal to receive a task reminder message related to a meeting; and
a fourth presentation unit configured to cause the client terminal to present task description information comprised in the task reminder message and present meeting description information of the meeting.

Clause 39. A task reminder method, comprising:
receiving a task reminder message generation instruction related to a meeting reminder message;
determining a reminded object and task description information; and
sending a task reminder message comprising the task description information and related to the meeting reminder message to the reminded object.

Clause 40. A task reminder method, comprising:
receiving a task reminder message related to a meeting reminder message; and presenting task description information comprised in the task reminder message, and presenting meeting description information in the meeting reminder message.

Clause 41. A task reminder method, comprising:
receiving a task reminder message generation instruction related to a meeting reminder message;
determining a reminded object and task description information; and
sending a task reminder message related to a meeting corresponding to the meeting reminder message to a reminded object that participates in the meeting and a task reminder message unrelated to the meeting to a reminded object that does not participate in the meeting, the task reminder message comprising the task description information.

Clause 42. A task reminder method, comprising:
receiving a task reminder message related to a meeting reminder message;
determining whether a logged-in user participates in a meeting corresponding to the meeting reminder message; and
presenting task description information comprised in the task reminder message and presenting meeting description information of the meeting when the logged-in user participates in the meeting; and presenting, by a client terminal, the task description information comprised in the task reminder message when the logged-in user does not participate in the meeting.

Clause 43. A method for generating a reminder message, comprising:
receiving a reminder message generation instruction related to a first reminder message;
determining a reminded object and reminder event description information; and
sending a second reminder message comprising the reminder event description information and related to the first reminder message to the reminded object.

Clause 44. A method for generating a reminder message, comprising:
generating a second reminder message related to a first reminder message according to a reminded object, reminder event description information, and the first reminder message; and
sending the second reminder message comprising the reminder event description information to the reminded object.

Clause 45. A method for presenting a reminder message, comprising:
receiving a second reminder message related to a first reminder message; and
presenting second reminder event description information comprised in the second reminder message, and presenting first reminder event description information corresponding to the first reminder message.

Clause 46. A task reminder method, comprising:
receiving a task reminder message generation instruction related to a meeting;
determining a reminded object and task description information; and
sending a task reminder message comprising the task description information and related to the meeting to the reminded object.

Clause 47. A task reminder method, comprising:
generating a task reminder message related to a meeting according to a reminded object, task description information, and the meeting; and
sending the task reminder message comprising the task description information to the reminded object.

Clause 48. A task reminder method, comprising:
receiving a task reminder message related to a meeting; and
presenting task description information comprised in the task reminder message, and presenting meeting description information of the meeting.

What is claimed is:

1. A method comprising:
receiving, by a client terminal, a task reminder message generation instruction related to a meeting reminder message;
determining, by the client terminal, a reminded object and task description information; and
sending, by the client terminal, a task reminder message comprising the task description information and related to the meeting reminder message to the reminded object.

2. The method of claim 1, wherein the receiving, by the client terminal, the task reminder message generation instruction related to the meeting reminder message comprises:
displaying, by the client terminal, a task creation option in a presentation interface of the meeting reminder message; and
determining, by the client terminal, that the task reminder message generation instruction is received in response to receiving a trigger operation for the task creation option.

3. The method of claim 1, wherein the receiving, by the client terminal, the task reminder message generation instruction related to the meeting reminder message comprises:
receiving, by the client terminal, a user creation operation for the task reminder message and a meeting binding operation for the task reminder message; and
determining, by the client terminal, that the task reminder message generation instruction related to the meeting reminder message is received in response to determining that the meeting reminder message is selected by the meeting binding operation.

4. The method of claim 1, wherein the task reminder message further comprises meeting description information in the meeting reminder message.

5. The method of claim 1, wherein the reminded object comprises a participant of a meeting corresponding to the meeting reminder message.

6. The method of claim 1, wherein the reminded object comprises an object that is selected by an object selection operation received by the client terminal.

7. The method of claim 1, wherein the reminded object has a task management permission for the task reminder message when the reminded object does not participate in a meeting corresponding to the meeting reminder message.

8. The method of claim 1, wherein the reminded object has a task management permission for the task reminder message when the reminded object participates in the meeting and is configured as a task leader.

9. A client terminal comprising:
one or more processors; and
one or more computer readable media storing computer-readable instructions that, executable by the one or more processors, cause the one or more processors to perform acts comprising:
receiving a task reminder message related to a meeting reminder message; and
presenting task description information comprised in the task reminder message and meeting description information in the meeting reminder message.

10. The client terminal of claim 9, wherein the presenting the task description information comprised in the task reminder message and the meeting description information in the meeting reminder message comprises:
presenting at least a part of the content of the meeting description information in a presentation area of the task reminder message.

11. The client terminal of claim 9, wherein the presenting the task description information comprised in the task reminder message and the meeting description information in the meeting reminder message comprises:
presenting at least a part of the content of the task description information in a presentation area of the meeting reminder message.

12. The client terminal of claim 9, wherein the presenting the task description information comprised in the task reminder message and the meeting description information in the meeting reminder message comprises:
displaying a first trigger option related to the meeting reminder message in a presentation area of the task reminder message, wherein the client terminal presents the meeting description information in the meeting reminder message in response to determining that the first trigger option is triggered.

13. The client terminal of claim 9, wherein the presenting the task description information comprised in the task reminder message and the meeting description information in the meeting reminder message comprises:
displaying a second trigger option related to the task description information in a presentation area of the meeting reminder message; and
presenting the task description information when the second trigger option is triggered.

14. The client terminal of claim 9, wherein the acts further comprise:
performing, by the client terminal, task management on a task event corresponding to the task reminder message according to a trigger operation for the task event.

15. One or more computer readable media storing computer-readable instructions that, executable by one or more processors, cause the one or more processors to perform acts comprising:
receiving a task reminder message generation instruction related to a meeting reminder message;
determining a reminded object and task description information; and
sending a task reminder message comprising the task description information and related to the meeting reminder message to the reminded object.

16. The one or more computer readable media of claim 15, wherein the receiving the task reminder message generation instruction related to the meeting reminder message comprises:
displaying, by the client terminal, a task creation option in a presentation interface of the meeting reminder message; and
determining, by the client terminal, that the task reminder message generation instruction is received in response to receiving a trigger operation for the task creation option.

17. The one or more computer readable media of claim 15, wherein the receiving the task reminder message generation instruction related to the meeting reminder message comprises:
receiving a user creation operation for the task reminder message and a meeting binding operation for the task reminder message; and
determining that the task reminder message generation instruction related to the meeting reminder message is received when the meeting reminder message is selected by the meeting binding operation.

18. The one or more computer readable media of claim 15, wherein the task reminder message further comprises meeting description information in the meeting reminder message.

19. The one or more computer readable media of claim 15, wherein the reminded object comprises at least one of the following:
a participant of a meeting corresponding to the meeting reminder message; and
an object that is selected by an object selection operation received by the client terminal.

20. The one or more computer readable media of claim 15, wherein:
the reminded object has a task management permission for the task reminder message when the reminded object does not participate in a meeting corresponding to the meeting reminder message; and
the reminded object has a task management permission for the task reminder message when the reminded object participates in the meeting and is configured as a task leader.
